(19) United States
(12) Patent Application Publication
(10) Pub. No.: US 2007/0265972 A1
(43) Pub. Date: Nov. 15, 2007

(54) Information distribution server system, information distribution method, and recording medium

(75) Inventor: Yuichiro Tsutsui, Shibuya-ku (JP)

Correspondence Address: BRINKS HOFER GILSON & LIONE, P.O. BOX 10395, CHICAGO, IL, 60610, US

(73) Assignee: Techfirm Inc., Tokyo (JP)

(21) Appl. No.: 11/825,091

(22) Filed: Jul. 2, 2007

Related U.S. Application Data
(62) Division of application No. 09/763,775, filed on Feb. 26, 2001, now abandoned.

(30) Foreign Application Priority Data
Sep. 7, 2000 (JP) PCT/JP00/06090

(51) Int. Cl. G06Q 30/00

(52) U.S. Cl. 705/52; 705/1

(57) ABSTRACT

An object of the present invention is to build an environment which provides adequate merits to both users and providers of applications and which enables distribution of various applications from providers to users. The status of payment of a predetermined usage fee which the user of each cellular phone must pay for a predetermined period is stored. Further, the status of usage of each application is detected. A license fee to be paid to the provider of the application is calculated on the basis of a ground total of usage fees and the usage status of the application and is output.

### TECHNICAL FIELD

The present invention relates to an information distribution server system, an information distribution method, and a recording medium, which are adapted to distribute various types of data, such as software applications.

### BACKGROUND ART

Since their introduction, there has been a significant improvement in the functions of cellular phones. In recent years, cellular phones having browsers installed have been introduced, which can connect to the Internet via a cellular phone network.

Although cellular phones are more portable than personal computers, they have greater limitations, such as small memory capacity, low data processing performance, a narrow communication band, and low communication speed. Therefore, each IP (Information Provider) which provides content to cellular phones determines the manner of describing contents and the specifications of communication protocol, etc. within the limitations of cellular phones. Examples of such specialized services for cellular phones include an i-mode service (registered trademark) provided by NTT DoCoMo, Inc., and a WAP (Wireless Access Protocol) service proposed by Phone.com, Inc.

However, these existing services for cellular phones mainly support reception and transmission of information which is created using HTML (HyperText Markup Language) or WAP, which have limited control and display capabilities.

In view of the foregoing, there has recently been proposed introduction into a cellular phone of an operating environment capable of full-scale execution of applications. For example, there have been plans to install a Java virtual machine—which is an environment necessary for the execution of Java (registered trademark) applications—into a cellular phone. This enables execution of a greater variety of applications in a cellular phone.

This environmental change means that a cellular phone, which has been used mainly as a terminal for simple input and output of data, will be capable of processing information and allowing a user to install and use various applications. In other words, although cellular phones are still inferior to personal computers in terms of information processing capability and display capability, it will become possible for cellular phones to perform processing which until now has been performed only by personal computers.

Meanwhile, for personal computers, several methods of purchasing applications have conventionally been used. In one method, a user purchases packaged application software directly from a retail outlet. In another method, frequently employed for shareware, a user downloads an application from a server on a network and makes a payment to the author of the application by a suitable money transfer method.

Although retail services for selling application software for cellular phones are not yet widespread, the same retail methods as those used for selling personal computer software can be employed.

However, applications for cellular phones are generally smaller than applications which operate on personal computers, and their processing areas are localized and limited. Therefore, unlike applications which operate on personal computers, such as word processors and spreadsheets, most applications for cellular phones are limited to temporary use and in many cases are designed not to be used permanently. Further, since cellular phones do not have a large-capacity recording medium such as a hard disk device used in personal computers, in some cases, a user must download the same application repeatedly, each time the user requires the application.

In view of the foregoing, users cannot be expected to purchase applications for cellular phones at high prices. This means that an application provider must set the price of each application relatively low.

From the above-described facts, it can be concluded that, regarding applications for cellular phones, companies and organizations having development capability and sufficient funds must develop applications by themselves or must obtain licenses from others and sell the applications. In other words, in the world of cellular phones, it must be said that applications having a low degree of completeness and those developed by individuals and small companies which cannot bear costs of distribution and advertisement are not viable. Such a situation is a disincentive to application developers, and consequently there is little possibility of making improvements or variations thereby hindering the development of applications.

### DISCLOSURE OF THE INVENTION

The present invention was accomplished in view of the above-described problems, and an object of the present invention is to build an environment which provides adequate merits to both users and providers of applications for radio portable terminals and which enables distribution of various applications from providers to users.

An information distribution server system according to the present invention is adapted to distribute applications to radio portable terminals in accordance with download requests from the radio portable terminals, each radio portable terminal being capable of utilizing an application downloaded via the Internet and a radio communication network. The information distribution system comprises: a user information table for storing information regarding a user of each radio portable terminal; a provider information table for storing information regarding a provider of each application; a payment-status management table for managing the status of payment of a predetermined usage fee which each user, who is listed in the user information table must pay for a predetermined period; a detection section for detecting the status of usage of each application; a usage-status management table for storing the detected usage status; and a computation section for calculating and outputting a license fee to be paid to each provider who is listed in the provider information table, on the basis of a ground total of usage fees determined by the payment-status management table and the usage status stored in the usage-status management table.

Such an information distribution server system enables each user to use a plurality of applications provided by a plurality of providers through payment of a predetermined usage fee and enables each provider to receive a stipulated license fee for an application.

The following two methods may be used for license fee calculation.

In a first method, the detection section detects the application usage status on an application-by-application basis; the usage-status management table stores the application usage status on an application-by-application basis; and the computation section allots a portion of the ground total of usage fees grasped by the payment-status management table as a ground total of license fees to be paid to the providers, and distributes and outputs, from the allotted ground total of license fees, a license fee to be paid to the provider of each application, in accordance with the usage status stored in the usage-status management table.

In a second method, the detection section detects the application usage status on a user-by-user basis; the usage-status management table stores the application usage status on a user-by-user basis; and the computation section allots a portion of usage fees paid by the users, as a license fee to be paid to the providers of the applications, distributes and outputs, from the allotted license fee, a license fee that each user must pay to each provider, in accordance with the usage status stored in the usage-status management table, and sums on a provider-by-provider basis of the license fees distributed and output with respect to all the users, thereby obtaining a license fee to be paid to each provider.

In addition to download count, activation count, execution time, point number with which the user votes for an application that the user considered as having a high added value can be used as a parameter for determining the usage status of the application. By determining the usage status in various manners, more reasonable license fees can be determined.

### BRIEF DESCRIPTION OF DRAWINGS

FIG. 1 is a block diagram showing the overall configuration of a system according to an embodiment of the present invention;

FIG. 2 is a block diagram showing the hardware configuration of a cellular phone used in the embodiment;

FIG. 3 is a schematic diagram showing the process configuration of the cellular phone used in the embodiment;

FIG. 4 is a schematic diagram showing the process configuration of a WWW server used in the embodiment;

FIG. 5 is a diagram showing example data items registered in a provider master table used in the embodiment;

FIG. 6 is a diagram showing example data items registered in an application-registration master table used in the embodiment;

FIG. 7 is a diagram showing example data items registered in an application-access management table used in the embodiment;

FIG. 8 is a diagram showing example data items registered in an application statistics table used in the embodiment;

FIG. 9 is a diagram showing example data items registered in a user master table used in the embodiment;

FIG. 10 is a diagram showing example data items registered in a last-activation date/time storing table used in the embodiment;

FIG. 11 is a diagram showing example data items registered in a user-access storing table used in the embodiment;

FIG. 12 is a diagram showing example data items registered in a user-payment payment management table used in the embodiment;

FIG. 13 is a diagram showing example data items registered in a download-ID management table used in the embodiment;

FIG. 14 is a diagram showing example data items registered in a last-download management table used in the embodiment;

FIG. 15 is a sequence diagram showing the flow of applet search processing carried out in the embodiment;

FIG. 16 is a sequence diagram showing the flow of the applet search processing carried out in the embodiment;

FIGS. 17A to 17F are schematic diagrams showing example screens displayed on a personal computer during the applet search processing carried out in the embodiment;

FIG. 18 is a sequence diagram showing the flow of applet download processing carried out in the embodiment;

FIG. 19 is a sequence diagram showing the flow of the applet download processing carried out in the embodiment;

FIG. 20 is a sequence diagram showing the flow of the applet download processing carried out in the embodiment;

FIGS. 21A to 21H are schematic diagrams showing example screens displayed on the cellular phone during the applet download processing carried out in the embodiment;

FIG. 22 is a diagram showing HTML data used in the embodiment;

FIG. 23 is a sequence diagram showing the flow of applet execution processing carried out in the embodiment;

FIG. 24 is a sequence diagram showing the flow of the applet execution processing carried out in the embodiment;

FIGS. 25A to 25D are schematic diagrams showing example screens displayed on the cellular phone during the applet execution processing carried out in the embodiment;

FIG. 26 is a flowchart showing the flow of a high-score registration processing carried out in the embodiment;

FIG. 27 is a sequence diagram showing the flow of point-voting processing carried out in the embodiment;

FIGS. 28A to 28C are schematic diagrams showing example screens displayed on the cellular phone during the point-voting processing carried out in the embodiment;

FIG. 29 is a flowchart showing the flow of license fee calculation processing carried out in the embodiment;

FIG. 30 is a flowchart showing the flow of the license fee calculation processing carried out in the embodiment;

FIG. 31 is a flowchart showing the flow of provider search processing carried out in the embodiment;

FIG. 32 is a schematic diagram showing an example screen displayed on the cellular phone during the provider search processing carried out in the embodiment;

FIGS. 33A to 33B are flowcharts showing the flow of the provider search processing carried out in the embodiment;

FIG. 34 is a schematic diagram showing an example of a display for displaying the result of the provider search processing carried out in the embodiment;

FIG. 35 is a flowchart showing the flow of application search processing carried out in the embodiment;

FIG. 36 is a schematic diagram showing an example of a display for displaying the result of the application search processing carried out in the embodiment;

FIG. 37 is a sequence diagram showing the flow of point-voting processing carried out in another embodiment; and

FIG. 38 is HTML data used in another embodiment.

### BEST MODE FOR CARRYING OUT THE INVENTION

An embodiment of the present invention will now be described with reference to the drawings. However, the present invention is not limited to the embodiment; various modifications can be made within the technical scope of the invention.

A: Configuration

(1) Overall Network Configuration

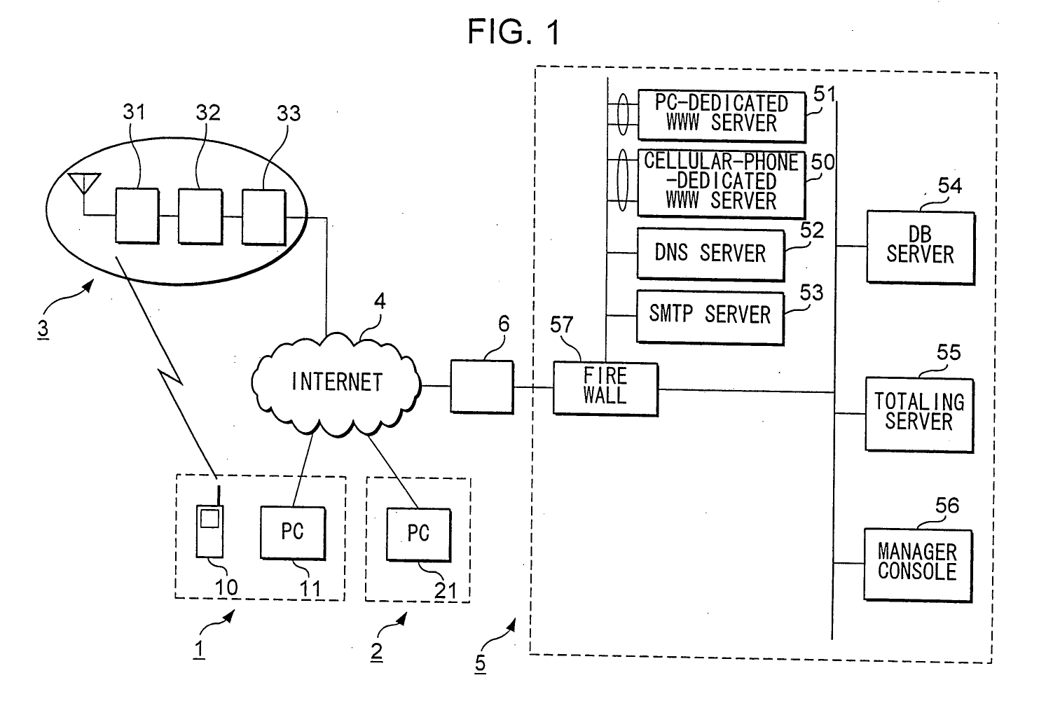

FIG. 1 is a block diagram showing the overall configuration of a system according to the embodiment. As shown in FIG. 1, the system is generally composed of a group of user terminals 1, a group of provider terminals 2, a packet communication network 3 for mobile communications, the Internet 4, and a group of servers 5.

As a whole, the system provides an environment that promotes the distribution of contents. Specifically, various applications are uploaded from the group of provider terminals 2 to the group of servers 5; and the applications are downloaded to the group of user terminals 1 in response to requests from the group of user terminals 1.

In the present embodiment, a computer program called “applet,” which is written in the Java (registered trademark) programming language, is exemplified as an “application.” However, the application is not limited thereto, and the concept of the aforementioned application encompasses any type of data that can be exchanged through the communication network.

Herein below, the individual constituent elements of the system will be described in detail.

The group of user terminals 1 is a group of terminals, each of the terminal in the group is operated by a user who pays a predetermined monthly charge to purchase a right that permits downloading and use of various applications registered and stored in the group of servers 5. The group of user terminals 1 includes terminals such as a cellular phone 10 and a personal computer 11.

The cellular phone 10 (radio portable terminal) receives call services which are provided through a mobile phone network(not illustrated). In addition, the cellular phone 10 performs radio communication with a base station 31 of the packet communication network 3 (radio communication network), thereby performing radio data communications. The packet communication network 3 includes the base station 31 distributed in a communication service area, a switching station 32 for performing packet-switching services, and communication lines for connecting them. The packet communication network 3 is connected to the Internet 4 via a gateway 33, thereby allowing two-way data communication to be implemented between the two different networks. The cellular phone 10 has the capability of downloading the applications from the group of servers 5 via the packet communication network 3 and the Internet 4.

The personal computer 11 can be connected to the Internet 4 through an Internet-connecting company (not illustrated)in order to perform communications. Through operation of the personal computer 11, a user can access the group of servers 5 in order to use an application search service.

The group of provider terminals 2 is a group of terminals, each of which is operated by a provider of the corresponding application(s), and includes a personal computer 20. As in the case of the personal computer 11, the personal computer 12 can be connected to the Internet 4 via an Internet-connecting company (not illustrated) in order to perform communications. The term “provider” refers to a party who holds a license for a certain application and who reserves the right to receive a part of the user-paid fee as compensation for using the application (hereinafter, the compensation will be referred to as a license fee).

In reality, a larger number of cellular phones 10, personal computers 11, and personal computers 20 exist; and the system can provide services to a larger number of users and providers. Herein, a personal computer is referred to as simply a PC.

The group of servers 5 (information-distribution server system) is connected to the Internet 4 via a router 6, and includes various servers for operating and managing dedicated sites that are used for distributing to the cellular phones 10 applications uploaded from the group of provider terminals 2.

As shown in FIG. 1, the group of servers 5 includes a cellular-phone-dedicated WWW (world wide web) server 50 (having a detection section, a provision section, a selection section, an error-transmission section, an inhibition-control section, a server-application storing section, a limiting section, and a common process interface); a personal-computer-dedicated WWW server 51 (having a communication section, a search/output section, a mail transmission section, and a screen generation section); a DNS (domain name system) server 52; an SMTP (simple mail transfer protocol) server 53 (having a mail transmission section); a database server 54 (having a detection section, a grasping section, a judgment section, and a common database); a totaling server 55 (having a detection section and a computation section); a manager console 56; a firewall server 57; and high-speed digital lines 58 for connecting the aforementioned servers to each other.

The cellular-phone-dedicated WWW server 50 is adapted to provide cellular-phone-dedicated WWW pages to the cellular phone 10 and to distribute applications to the cellular phone 10.

The PC-dedicated WWW server 51 is adapted to provide PC-dedicated WWW pages to the PC 11, PC 21, etc.

The DNS server 52 is a well-known server that stores a host name and a corresponding IP (Internet protocol) address allocated to each node on the Internet 4, and provides a service for effecting mutual conversion. The SMTP server 53 is a well-known server for supporting SMTP.

The database server 54 has a large-capacity storage device for storing various uploaded applications and various tables to be described below.

The totaling server 55 uses the various tables stored in the database server 54 to thereby perform calculation regarding content-usage statuses and calculation of license fees according to the content-usage statuses.

The manager console 56 is a computer that a manager of the group of servers 5 operates in order to maintain the servers constituting the group of servers 5.

The firewall server 57 is also well-known. The firewall server 57 provides a function of excluding unauthorized access from external networks.

(2) Configuration of the Cellular Phone 10

The configuration of the cellular phone 10 will now be described.

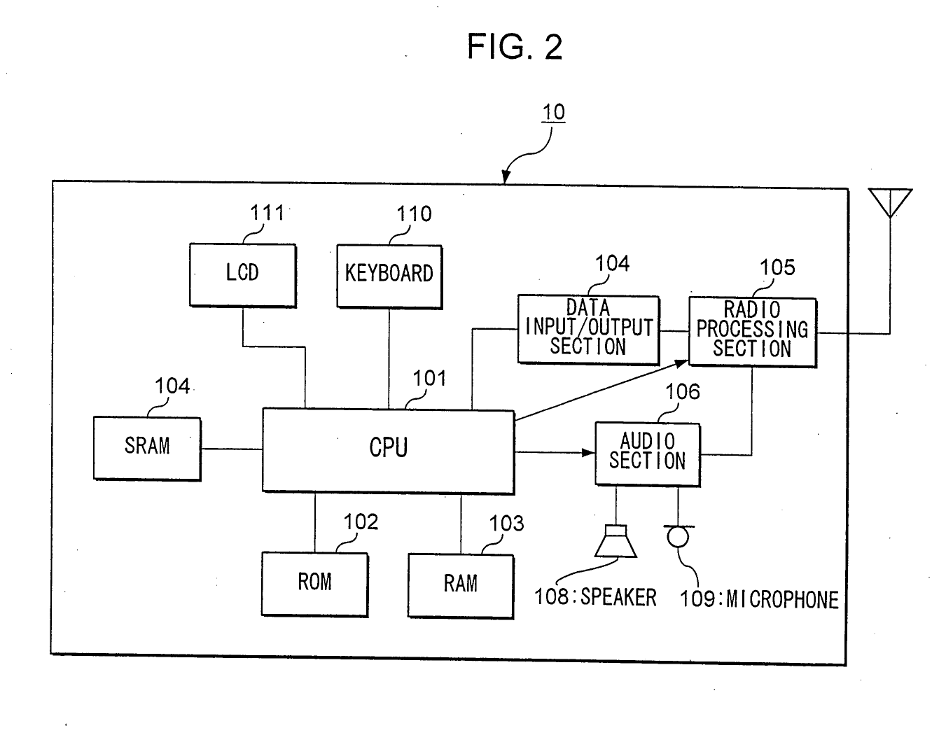

First, the hardware configuration of the cellular phone 10 will be described with reference to FIG. 2. As shown in FIG. 2, the cellular phone 10 has a CPU (central processing unit) 100, ROM (read-only memory) 101, RAM (random access memory) 102, SRAM (static random access memory) 103, a data input/output section 104, a radio-processing section 105, an audio-processing section 106, a speaker 107, a microphone 108, a keyboard 109, and an LCD (liquid crystal display) 110. These components are connected to one another.

The ROM 101 stores therein a variety of control programs and other data, and the CPU 100 reads out the control programs in order to execute various types of control processing. During the processing, the RAM 102 is used as a work area for the CPU 100 and for other purposes. The programs stored in the ROM 101 include not only firmware that supports the basic operation of the cellular phone 10, but also a browser and various applications described below. The SRAM 103 caches pages provided by the cellular-phone-dedicated WWW server 50 and stores applications downloaded from the cellular-phone-dedicated WWW server 50.

The radio-processing section 105 has a frequency synthesizer, an amplifier, and a modulator/demodulator circuit. The radio-processing section 105 executes various types of processing, such as frame synchronization/separation and error detection/correction, for signals transmitted and received via an antenna 105-1. Thus, the radio-processing section 105 performs processing suitable for signals transmitted through circuit switching and processing suitable for signals transmitted through packet switching. Data are transferred between the radio-processing section 105 and the CPU 100 via the data input/output section 104.

The audio-processing section 106 is connected to the speaker 107 and the microphone 108 and performs predetermined processing for voice signals.

The keyboard 109 is an input interface that allows the user to perform various operations. The LCD 110 is an interface for displaying various types of information.

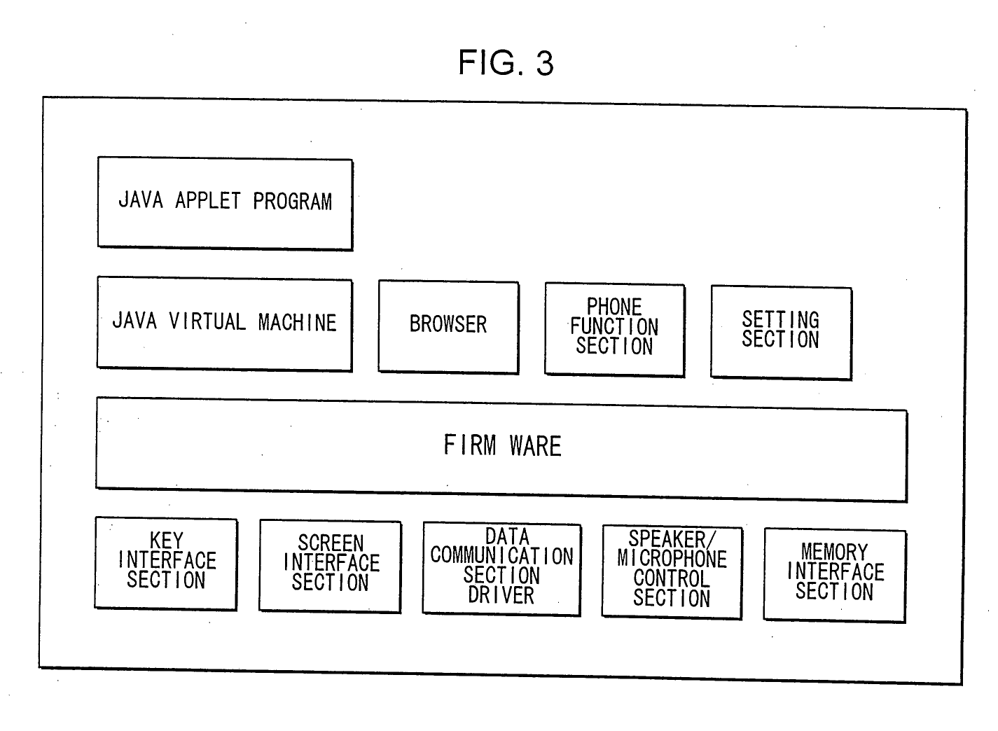

Next, the process configuration of the cellular phone 10 will be described with reference to FIG. 3. As shown in FIG. 3, the lowest layer is composed of a key-interface section KI, a display-interface section DI, a data-communication driver DD, a speaker/microphone control section SM, and a memory interface MI, all of which relate to hardware control of the cellular phone 10.

The layer immediately above the lowest layer is composed of firmware FW, which supports the basic processing performed by the cellular phone 10.

The layer immediately above the firmware FW is composed of a Java virtual machine JVM, a browser BS, a telephone-function section TS, and a setting section SS. The layer immediately above the Java virtual machine JVM is a Java applet program AAP.

The Java applet program AAP includes applications written in Java (registered trademark). The Java applet program AAP is downloaded from the cellular-phone-dedicated WWW server 50 to the cellular phone 10 and is executed on the Java virtual machine JVM.

(3) Configuration of the Cellular-Phone-Dedicated WWW Server

Next, the configuration of the cellular-phone-dedicated WWW server 50 will be described.

The cellular phone-dedicated WWW server 50 has the same hardware configuration as those of well-known servers. That is, although not shown, the cellular phone-dedicated WWW server 50 includes a CPU, ROM, RAM, a hard disk device, a communication interface, etc., which are connected to one another by means of a bus.

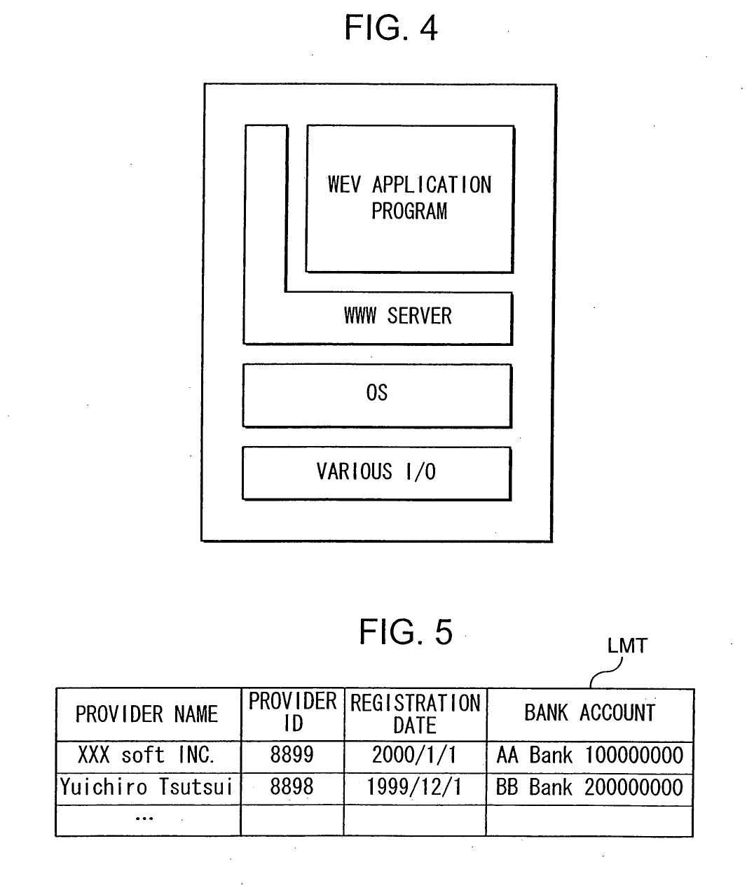

FIG. 4 is a schematic diagram showing the process configuration of the cellular-phone-dedicated WWW server 50. As shown in FIG. 4, the configuration includes an OS (operating system), a WWW server, and web application programs, which are arranged in this order from the lowest layer including various interfaces toward the upper layers.

(4) Configuration of the Database Server 54

As described above, the database server 54 holds various types of information in the form of tables. The information is used for the operation and management of the system.

Herein below, data items registered in various tables in the database server 54 will be described.

FIG. 5 shows example data items registered in a provider master table LMT (provider information table).

As shown in FIG. 5, the provider master table LMT contains various types of provider information, such as provider names, provider IDs, registration dates, and bank account numbers. These data items are registered in the table LMT in a correlated manner. “Provider name” refers to a name that a provider notifies to the group of servers 5. “Provider ID” refers to an ID that identifies each provider. “Registration date” refers to a date on which a provider registers the provider information. “Bank account number” refers to an account that a provider holds, and license fees due to be received by the provider are transferred to the account.

The provider master table LMT is used mainly for searching the status of usage of applications and license fees in accordance with a request from the corresponding provider and for processing carried out for transferring license fees.

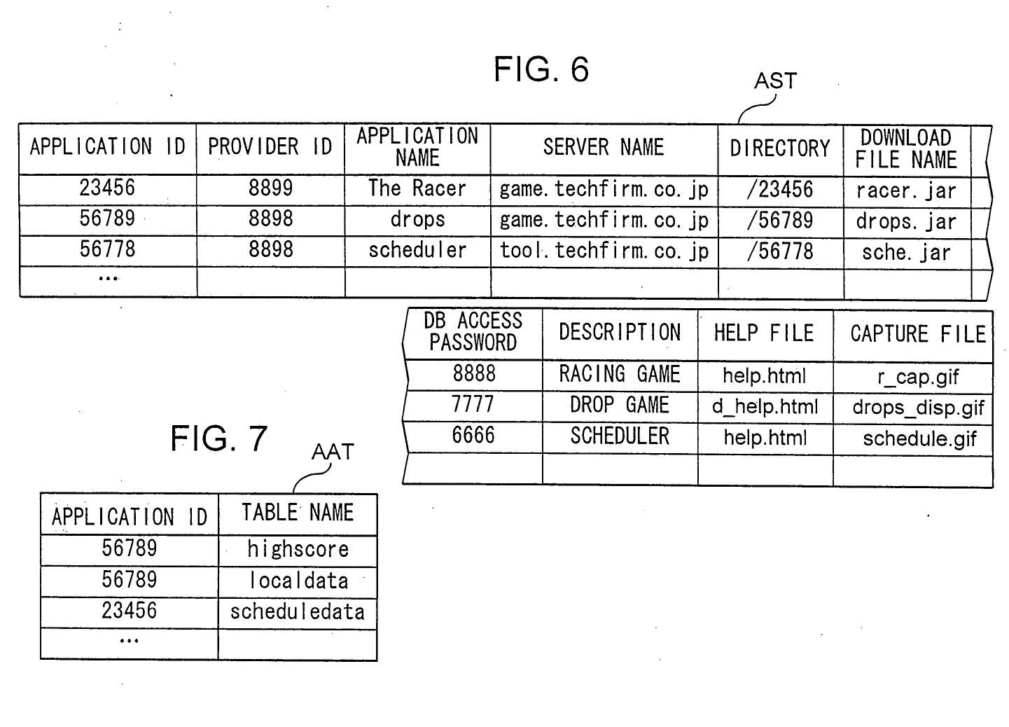

FIG. 6 shows example data items registered in an application registration table AST.

As shown in FIG. 6, the table AST contains various types of registered information, such as application IDs, provider IDs, application names, server names, directories, download file names, DB access passwords, descriptions, help files, and capture files.

“Application ID” refers to an ID allocated to each application for the purpose of identification. “Provider ID” is as described above. “Application name” refers to the name of an application. “Server name” refers to a host name of a server in which the application is stored. “Directory” refers to the name of a directory in the server in which the application is stored. “Download file name” refers to the name of a file stored in the server. Downloading of the application from the group of servers 5 to the cellular phone 10 is performed with designation of the server name, the directory, and the download file name.

“DB access password” refers to a password that a provider uses in order to access the database server 54 to retrieve information regarding an application. “Description” refers to a sentence that is used for describing the details of the application for a user. For example, the description is displayed on the PC 11 or the cellular phone 10 when a user searches or downloads the application. “Help file” refers to the name of a file that contains help information to be provided to the user when the user searches or downloads the application. “Capture file” refers to the name of a file that contains video information used for visually presenting the details of the application to the user.

The application-registration master table AST is used primarily when one of the users searches and downloads an application and when one of the providers searches information regarding license fee and application-usage status.

FIG. 7 shows example data items registered in an application-access management table AAT (a limiting section and a common process interface).

As shown in FIG. 7, the table AAT contains registered application IDs and table names. “Table name” refers to the name of a table that an application can access when the application is executed. For example, an application represented by application ID “56789” (which is assumed to be a game software application) is permitted to access a high-score table (not illustrated)for registration of a high score. That is, the application represented by application ID “56789” is permitted to register the high score of the game.

As described above, accessible table(s) are defined for each application, so that access by an unauthorized application can be prevented.

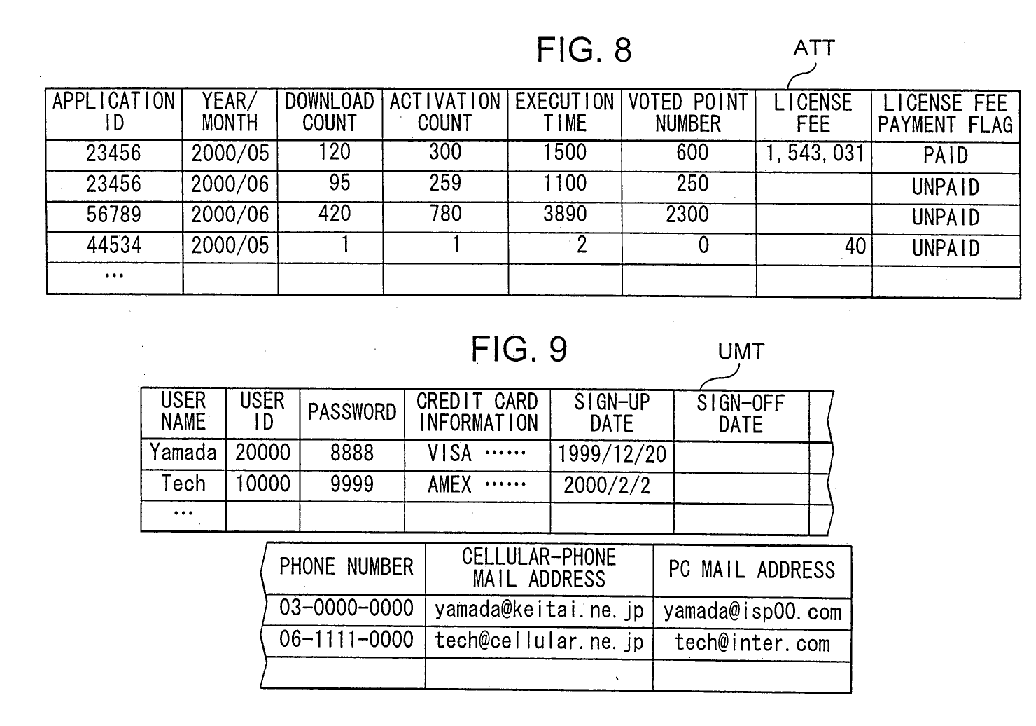

FIG. 8 shows example data items registered in an application statistics table ATT (usage-status management table).

As shown in FIG. 8, application IDs, years and months, download counts, activation counts, execution times, voted-point numbers, license fees, and license-fee payment flags are registered in the application statistics table ATT.

This table is used for determining the usage status of each application. “Year and month” refers to a period for which the usage status of the corresponding application is grasped. “Download count” refers to the number of times the specified application was downloaded to the cellular phone 10 during the period indicated by the year and month. “Activation count” refers to the number of times the specified application was activated on the cellular phone 10 during the period indicated by the year and month. “Execution time” refers to a cumulative time during which the specified application was executed on the cellular phone 10 during the period indicated by the year and month.

When a user uses an application, the user can rate the application on the basis of practicality and fun. “Voted-point number” refers to the total number of points awarded by voting. “License fee” refers to a fee that is to be paid to the corresponding provider as a consideration for using the application. The fee is calculated by making use of a calculation expression described below according to the usage status of the application. “License-charge payment flag” refers to a flag status that represents whether or not the calculated license fee has already been paid to the provider.

FIG. 9 shows example data items registered in a user master table UMT (user information table).

As shown in FIG. 9, the table UMT contains information related to users, such as user names, user IDs, passwords, credit card numbers, sign-up dates, sign-off dates, telephone numbers, cellular phone mail addresses, and PC mail addresses. “User name” refers to the name of a user. “User ID” refers to an ID which is allocated to and used to identify the user. “Password” refers to a password which the user must use to log in the group of servers 5 and for other purposes. The user ID and password are authenticated. “Credit card number” refers to a contract number of a credit card held by the user. The credit contract identified by the credit card number is used to charge application usage fees.

“Sign-up date” refers to a date on which the user signed up. “Sign-off date” refers to a date on which the user signed off. “Phone number” refers to the user's telephone number. “Cellular phone mail address” refers to a mail address allocated to the cellular phone 10. The user of the cellular phone 10 can download various applications by making use of the “Cellular phone mail address”. “PC mail address” refers to a mail address which is allocated to the PC 11 and used by the user of the PC 11.

For example, the table UMT is used when the user performs login operations and when mail is sent to the user.

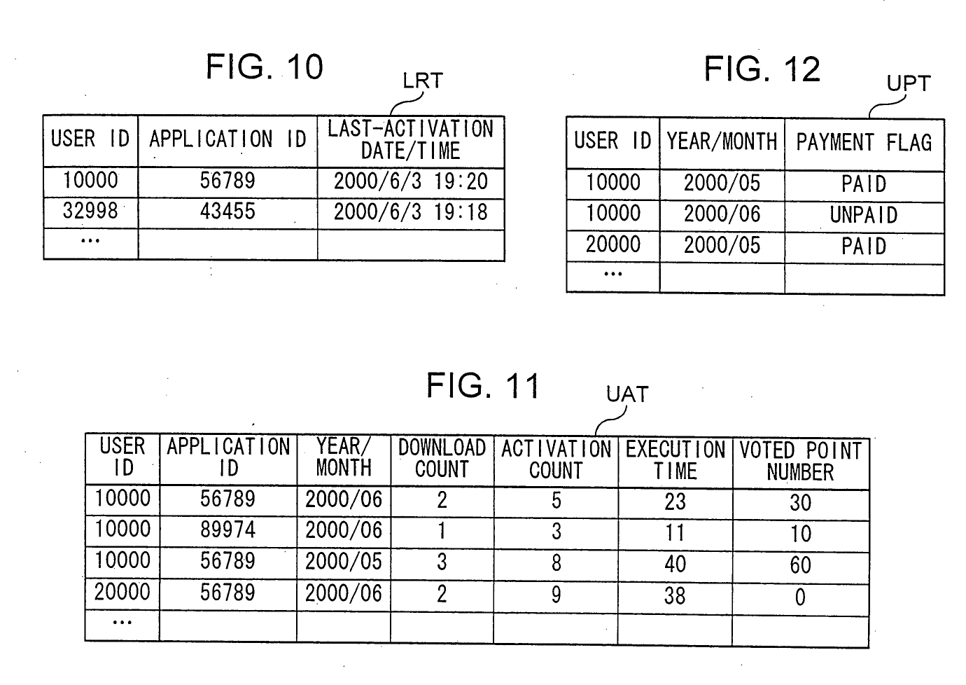

FIG. 10 shows example data items registered in a last-activation date/time storing table LRT.

As shown in FIG. 10, user IDs, application IDs, and last-activation dates and times are registered in the last-activation date/time storing table LRT. When an application is activated on the cellular phone 10, an activation notification is transmitted from the cellular phone 10 to the cellular-phone-dedicated www server 50. In response to the activation notification, last-activation date and time are registered in the last-activation date/time storing table LRT.

Each user can perform the aforementioned point voting for limited applications which the user has downloaded and activated during a specific period in the past. The last-activation date/time storing table LRT is used by the user to choose an application(s) for which the user can perform point voting.

FIG. 11 shows example data items registered in a user-access storing table UAT (usage-status management table).

As shown in FIG. 11, user IDs, application IDs, years and months, download counts, activation counts, execution times, and voted-point numbers are registered in the user-access storing table UAT. “Download count” refers to the number of times the corresponding user downloaded the specified application to the cellular phone 10 during the period indicated by the year and month. “Activation count” refers to the number of times the corresponding user activated the specified application on the cellular phone 10 during the period indicated by the year and month. “Execution time” refers to a total time over which the corresponding user executed the specified application on the cellular phone 10 during the period indicated by the year and month. “Voted-point number” refers to total number of points awarded by the user to the application during the period indicated by the year and month.

That is, the table UAT is used for determining the usage status of each application, and according to the information registered in the table UAT, the usage status of each application is determined. As a result, the license fee is determined.

FIG. 12 shows example data items registered in a user-payment management table UPT (payment-status management table).

As shown in FIG. 12, user IDs, years and months, and payment flags are registered in the table UPT. “Payment flag” refers to a status flag indicating whether or not the usage fee has already been paid by the corresponding user.

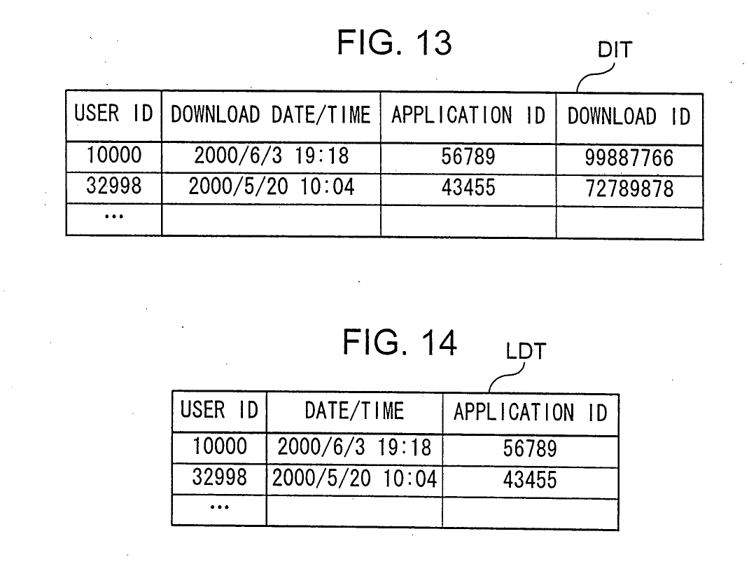

FIG. 13 shows example data items registered in a download-ID management table DIT.

As shown in FIG. 13, user IDs, download dates and times, application IDs, and download IDs are registered in the download-ID management table DIT. “Download ID” refers to a unique ID issued each time downloading is requested by the cellular phone 10. The table DIT contains all download IDs having been issued. As described below, the download ID is used to reject a request for an unauthorized application.

FIG. 14 shows example data items registered in a last-download management table LDT.

As shown in FIG. 14, user IDs, application IDs, and last-download dates and times are registered in the table LDT. As in the case of the table LRT, the table LDT is used by each user to choose an application for which the user can perform point voting.

B: Operation

The operation of the embodiment having the above-described configuration will be described.

Herein below, while “applet” is used as an application, the operations performed during applet search, applet download, applet execution, applet point voting, license-fee calculation, and various searching operations performed by providers will be described, in this order.

(1) Applet Search

A user can access the group of servers 5 through operation of the PC 11 in order to search a desired applet.

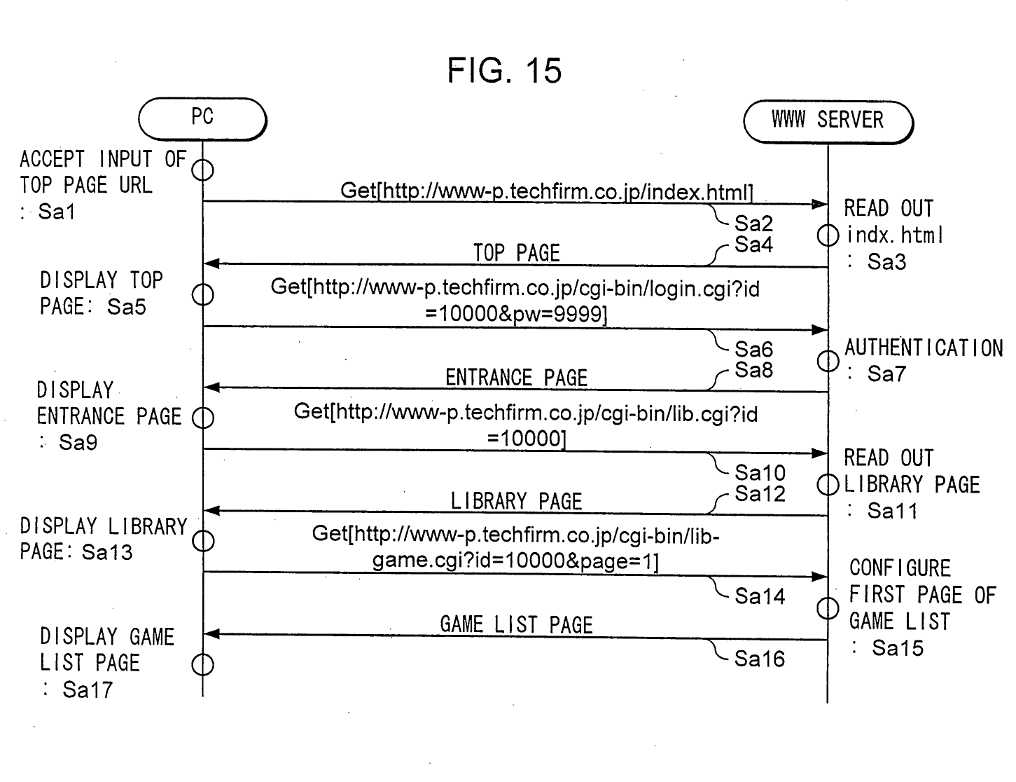

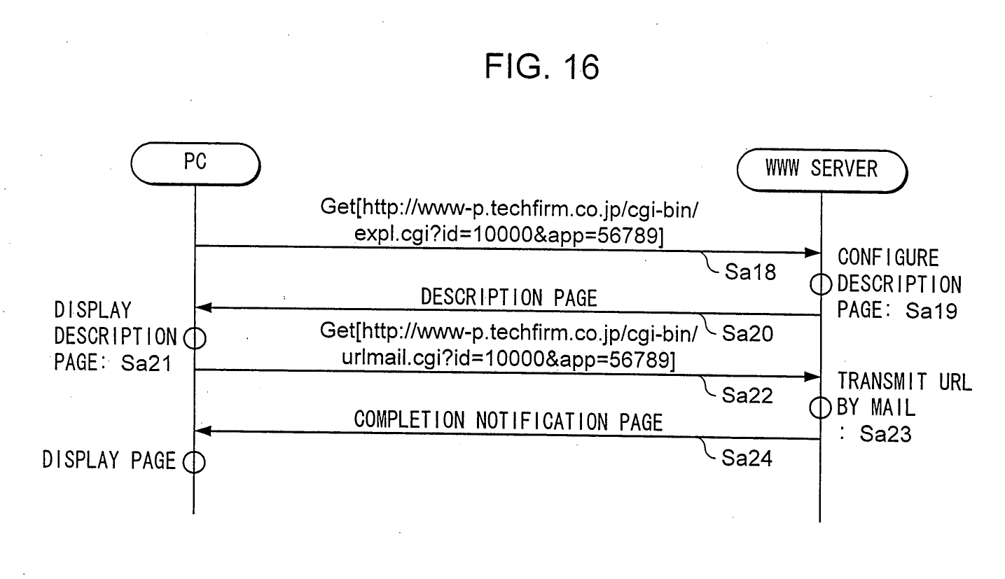

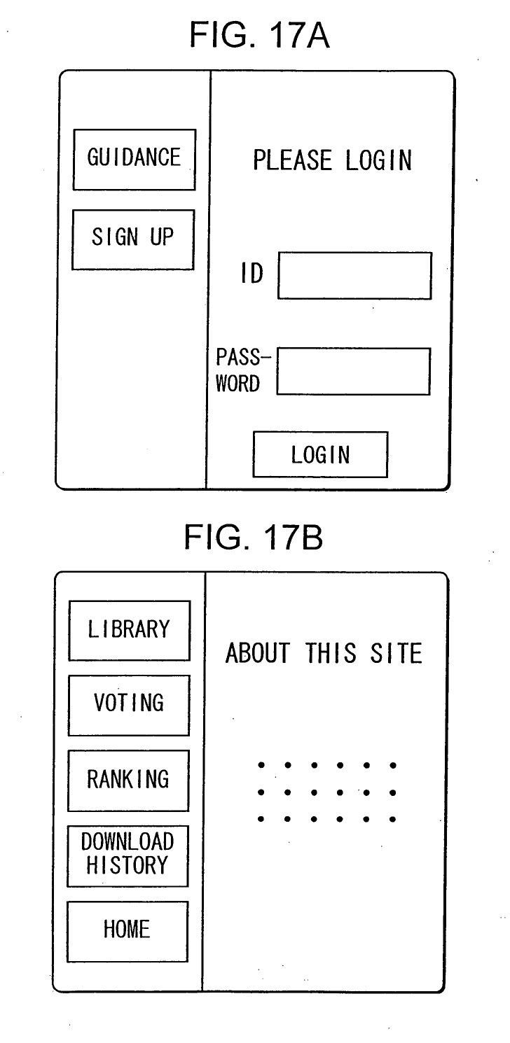

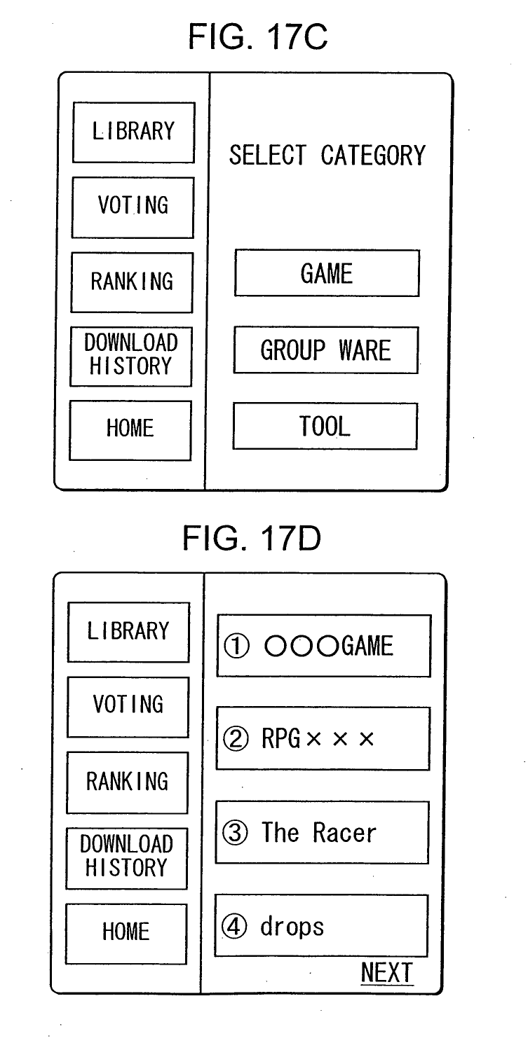

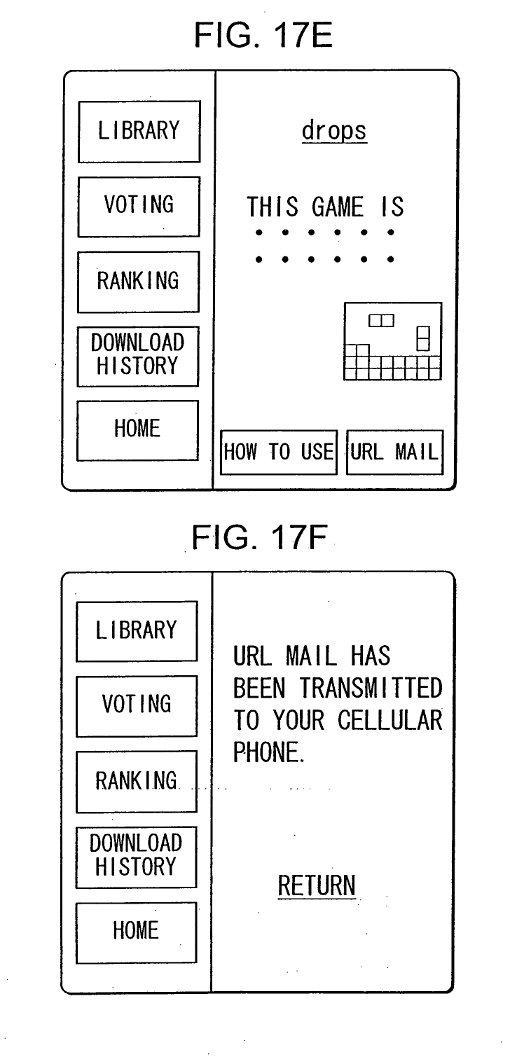

FIGS. 15 and 16 are sequence diagrams showing the operations of the PC 11 and the PC-dedicated WWW server 51 during applet search. FIG. 17 A to F show example screens that are displayed on the PC 11 during the applet search.

As shown in FIG. 15, first, a user operates the PC 11 to start a browser, and inputs a URL (which in the figure is assumed to be “(scheme)://www-p.techfirm.co.jp/index.html”, scheme is for example, “http:”) of a top page held in the PC-dedicated WWW server 51. Subsequently, the PC 11 accepts this operation (step Sa1). At this time, the method of accessing the top page is not limited to the input of the URL, and the top page may be accessed from a link appearing on a different page.

Subsequently, the PC 11 sends to the Internet 4 a request for accessing the top page (step Sa2). As shown in FIG. 15, this request includes the character string “(scheme)://www-p.techfirm.co.jp/index.html” (scheme is “http:”, for example.) specified by a GET method.

Upon receipt of the aforementioned request signal via the Internet 4, the PC-dedicated WWW server 51 reads out the top page specified by the request URI (uniform resource identifier) from the hard disk device (step Sa3) and transmits it to the PC 11 (step Sa4).

Upon receipt of data of the aforementioned top page, the PC 11 interprets the data and displays the top page on its display section (step Sa5). The page displayed in this step is used for logging in to the PC-dedicated WWW server 51. For example, as shown in FIG. 17A, a message for prompting entry of a user ID and a password is displayed in a predetermined field.

When the user inputs a user ID and a password and performs an operation for commanding login, the PC 11 transmits a login request to the PC-dedicated WWW server 51 (step Sa6). For example, when “10000” is input as a user ID and “9999” is input as a password, the request includes the character string “(scheme)://www-p.techfirm.co.jp/cgi-bin/login.cgi?id=10000&pw=9999” (scheme is “http:”, for example) specified by the GET method.

In response to the above request, the PC-dedicated WWW server 51 activates a CGI (common gateway interface) that corresponds to login.cgi, in order to judge whether or not the combination of user ID “10000” and password “9999” is a valid combination (step Sa7), by reference to the user master table UMT in the database server 54. When the combination is judged to be valid, the PC-dedicated WWW server 51 configures a subsequent entrance page and transmits it to the PC 11 (step Sa8). In contrast, when the combination is determined to be invalid, the PC-dedicated WWW server 51 configures an error screen and transmits it to the PC 11.

The character string “id=10000” representing the user ID is incorporated into data that are transmitted from the PC 11 to the PC-dedicated WWW server 51. This allows the PC-dedicated WWW server 51 to manage individual sessions that are subsequently executed between the PC 11 and the PC-dedicated WWW server 51.

Upon receipt of data of the entrance page, the PC 11 interprets the data and displays the entrance page on its display section (step Sa9). As shown in FIG. 17B, the page displayed in this step includes a brief description of the site and various menu items.

When the user wishes to perform applet search, the user simply clicks a “library” button shown in FIG. 17B. In response to the click operation, the PC 11 transmits a request to the PC-dedicated WWW server 51 for a library service (step Sa10). This request includes the character string “(scheme)://www-p.techfirm.co.jp/cgi-bin/lib.cgi?id=10000” (scheme is “http:”, for example) specified by the GET method.

In response to the above request, the PC-dedicated WWW server 51 activates lib.cgi and configures a library page (step Sa11), and transmits the library page to the PC 11 (step Sa12).

Upon receipt of data of the library page, the PC 11 interprets the data and displays the library page on its display section (step Sa13). As shown in FIG. 17C, the library page displayed in this step is used for selecting the category of an applet to be searched. Here, the user is assumed to have selected “game” by means of clicking the “game” button.

In response to the click operation, the PC 11 transmits a request to the PC-dedicated WWW server 51 for a page which lists game applets (step Sa14). This request includes the character string “(scheme)://www-p.techfirm.co.jp/cgi-bin/lib-game.cgi?id=10000&page1” (scheme is “http:”, for example) specified by the GET method.

In response to the above request, the PC-dedicated WWW server 51 activates lib-game.cgi and configures a first page of the game list (step Sa15), and transmits the page to the PC 11 (step Sa16).

Upon receipt of data of the first page of the game list, the PC 11 interprets the data and displays the first page of the game list on its display section (step Sa17). As shown in FIG. 17D, the page displayed in this step includes a list of titles of various games. Here, the user is assumed to have clicked a title “drops” shown in FIG. 17D in order to select a game “drops.” In some cases, the game list is composed of a plurality of pages rather than a single page. In this case, the user clicks a “next” button shown in FIG. 17D. In response thereto, a request including the character string “(scheme)://www-p.techfirm.co.jp/cgi-bin/lib-game.cgi?id=10000&page2” (scheme is “http:”, for example) is transmitted from the PC 11 to the PC-dedicated WWW server 51, whereby a second page of the game list is provided. As described above, when the last portion of the request URI includes a description “pageN”, the N-th page of the game list page is provided.

In response to the above click operation, the PC 11 transmits a request to the PC-dedicated WWW server 51 for a description regarding the game “drops” (step Sa18). This request includes the character string “(scheme)://www-p.techfirm.co.jp/cgi-bin/expl.cgi?id=10000&app=56789.” (scheme is “http:”, for example) In the character string, “app=56789” represents an application ID allocated to the game “drops.”

In response to the above request, the PC-dedicated WWW server 51 activates expl.cgi, thereby configuring a description page for the game “drops” (step Sa19), and transmits the page to the PC 11 (step Sa20). The PC-dedicated WWW server 51 obtains a description and a capture file for the specified applet by reference to the application-registration master table AST in the database server 54 and configures the description page on the basis of the thus-obtained description and capture file.

Upon receipt of data of the description page, the PC 11 interprets the data and displays the description page on its display section (step Sa21). As shown in FIG. 17E, the page displayed in this step includes a description for explaining the contents of “drops” and a capture that visually shows scenes of the game in the form of motion pictures.

The user reads the description. When the user desires to download the game to the cellular phone 10, the user clicks a button “URL mail” shown in FIG. 17E.

In response to the click operation, the PC 11 transmits to the PC-dedicated WWW server 51 a request for transmission of an access URL to the cellular phone 10 (step Sa22). The access URL is used to download “drops” to the cellular phone 10. The request includes the character string “(scheme)://www-c.techfirm.co.jp/cgi-bin/urlmail.cgi?id=10000&app=56789” (scheme is “http:”, for example) specified by the GET method.

In response to the above-described request, the PC-dedicated WWW server 51 activates urlmail.cgi to thereby generate an electronic mail containing an access URL ((scheme)://www-p.techfirm.co.jp/cgi-bin/expl.cgi?id=10000&app=56789) (scheme is “http:”, for example) for the game software “drops” specified by the aforementioned request. Subsequently, the PC-dedicated WWW server 51 transmits the thus-generated electronic mail to a mail address allocated to the cellular phone 10 (step Sa23). In this step, the mail address of the cellular phone 10, which serves as a destination address, can be grasped by reference to the user master table UMT.

Upon completion of transmission of the electronic mail, the PC-dedicated WWW server 51 generates a completion-notification page, and transmits the page to the PC 11 (step Sa24).

Having received data of the completion-notification page, the PC 11 interprets the data and displays the completion-notification page on its display section (step Sa25), to thereby complete the processing shown in FIG. 16.

After receipt of the electronic mail including the access URL, the user selects the access URL included in the mail by use of the browser of the cellular phone 10. This enables the cellular phone 10 to access directly the site designated by the access URL. Thus, it becomes unnecessary for the user to input the access URL, which input is cumbersome on the cellular phone 10. In addition, it becomes unnecessary for the user to perform complicated search operations on the cellular phone 10, thereby providing the user with significant convenience.

(2) Applet Download

Herein below, applet download processing will be described.

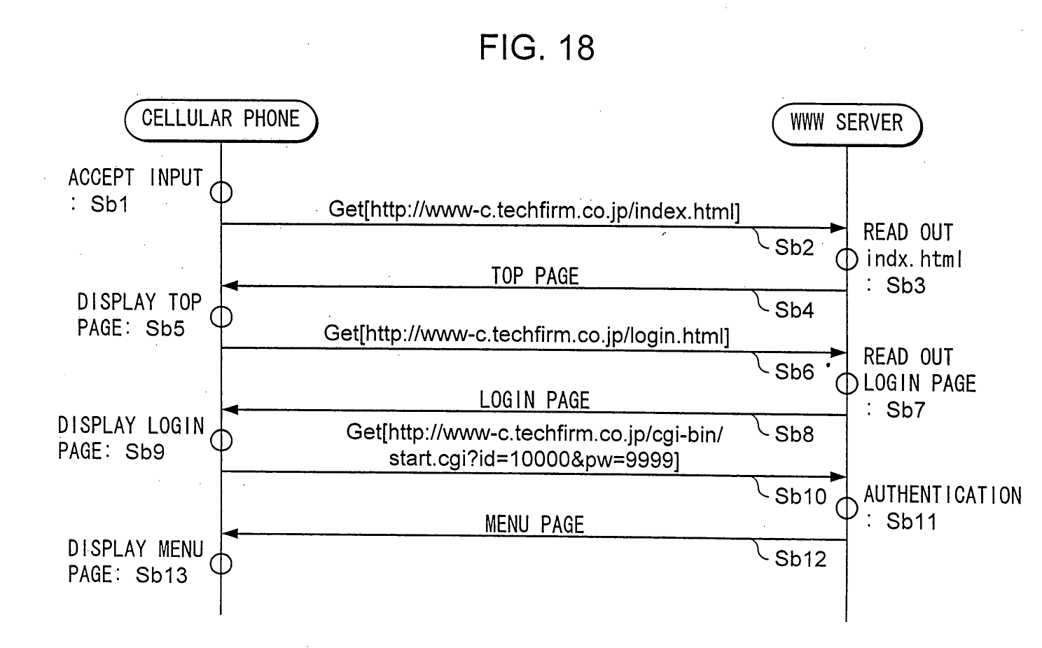

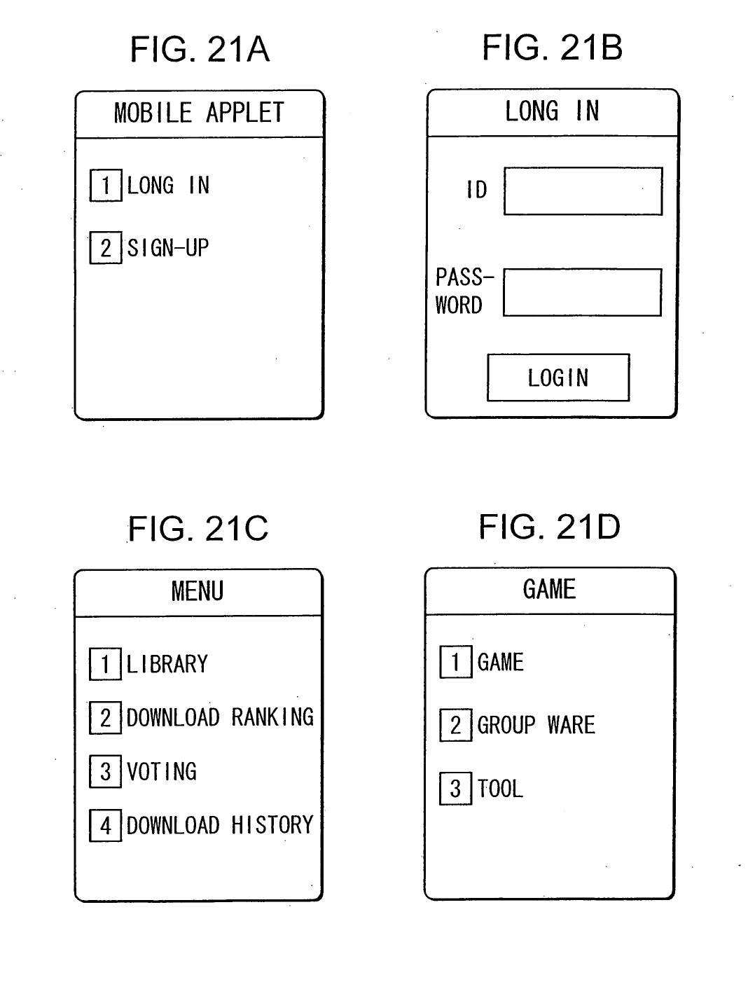

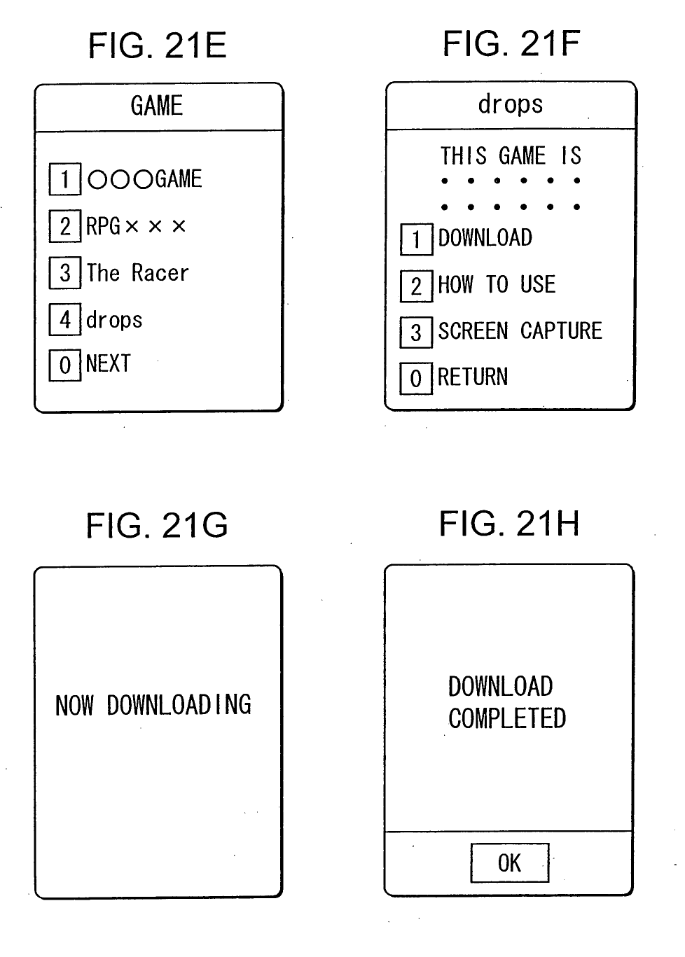

FIGS. 18 to 20 are sequence diagrams showing the operations of the cellular phone 10 and the cellular-phone-dedicated WWW server 50 during applet download. FIGS. 21 A to H show example screens that are displayed on the LCD 111 of the cellular phone 10 during the applet download operation.

As shown in FIG. 18, first, the user operates the cellular phone 10 to start the browser, and inputs a URL (which is assumed to be “(scheme)://www-c.techfirm.co.jp/index.html”) (scheme is “http:”, for example) of a top page held in the cellular-phone-dedicated WWW server 50. In response, the cellular phone 10 accepts the aforementioned input operation (step Sb1). At this time, the method of accessing the top page is not limited to the input of the URL, and the top page may be accessed from a link appearing on a different page.

Subsequently, the cellular phone 10 sends to the Internet 4 a request for accessing the aforementioned top page (step Sb2). As shown in FIG. 18, this request includes the character string “(scheme)://www-c.techfirm.co.jp/index.html” (scheme is “http:”, for example) specified by the GET method.

Upon receipt of the aforementioned request via the Internet 4, the cellular-phone-dedicated WWW server 50 reads out from the hard disk device the top page specified by the request URI (step Sb3). Then, the cellular-phone-dedicated WWW server 50 transmits the top page to the cellular phone 10 (step Sb4).

Upon receipt of data of the aforementioned top page, the cellular phone 10 interprets the data and displays the top page on the LCD 111 (step Sb5). The page displayed in this step allows the user to apply for membership required for receiving the service provided by the cellular phone-dedicated WWW server 50 or to log in to the service. For example, the page has a configuration as shown in FIG. 21A.

When the user selects a “login” button shown in FIG. 21A, the cellular phone 10 transmits a login request to the cellular phone-dedicated WWW server 50 (step Sb6). This request includes the character string “(scheme)://www-c.techfirm.co.jp/login.html” (scheme is “http:”, for example) specified by the GET method.

Having received the aforementioned request, the cellular-phone-dedicated WWW server 50 reads out from the hard disk device a login page specified by the request URI (step Sb7), and transmits the login page to the cellular phone 10 (step Sb8).

Upon receipt of data of the login page, the cellular phone 10 interprets the data and displays the login page on the LCD 111 (step Sb9). The login page displayed in this step has, for example, a configuration as shown in FIG. 21B. A message for prompting input of a user ID and a password is displayed in a predetermined field.

When the user inputs a user ID and a password and performs an operation for commanding login, the cellular phone 10 transmits a login request to the cellular-phone-dedicated WWW server 50 (step Sb10). For example, when “10000” is input as a user ID and “9999” is input as a password, the request includes the character string “(scheme)://www-c.techfirm.co.jp/cgi-bin/start.cgi?id=10000&pw=9999” (scheme is “http:”, for example) specified by the GET method.

In response to the aforementioned request, the cellular-phone-dedicated WWW server 50 activates start.cgi in order to check whether or not the combination of user ID “10000” and password “9999” is valid, by reference to the user master table UMT in the database server 54 (step Sb11).

If the combination is determined to be valid, the cellular-phone-dedicated WWW server 50 configures a subsequent menu page and transmits the menu page to the cellular phone 10 (step Sb12). If the combination is determined to be invalid, the cellular-phone-dedicated WWW server 50 configures a predetermined error screen and transmits the error screen to the cellular phone 10. The character string “id=10000” representing the user ID is incorporated into data that are transmitted from the cellular phone 10 to the cellular-phone-dedicated WWW server 50. This allows the cellular-phone-dedicated WWW server 50 to manage individual sessions that are subsequently executed between the cellular phone 10 and the cellular-phone-dedicated WWW server 50.

Upon receipt of data of the menu page, the cellular phone 10 interprets the data and displays the menu page on the LCD 111 (step Sb13). As shown in FIG. 21C, the page displayed in this step lists various menu items.

When the user wishes to perform applet downloading, the user simply clicks a “library” button shown in FIG. 21C. In response to the click operation, the cellular phone 10 transmits to the cellular-phone-dedicated WWW server 50 a request for a library page (step Sb14). This request includes the character string “(scheme)://www-c.techfirm.co.jp/cgi-bin/libtop.cgi?id=10000” (scheme is “http:”, for example) specified by the GET method.

In response to the above request, the cellular-phone-dedicated WWW server 50 activates lib.cgi and configures a library page (step Sb15), and transmits the library page to the cellular phone 10 (step Sb16).

Upon receipt of data of the library page, the cellular phone 10 interprets the data and displays the library page on the LCD 111 (step Sb17). As shown in FIG. 21D, the library page displayed in this step is used for selecting a category of an applet to be downloaded from the database server 54. Here, the user is assumed to have selected “game” shown in FIG. 21D.

In response to the selection operation, the cellular phone 10 transmits to the cellular-phone-dedicated WWW server 50 a request for a game list (step Sb18). This request includes the character string “(scheme)://www-c.techfirm.co.jp/cgi-bin/lib-game.cgi?id=10000&page1” (scheme is “http:”, for example) specified by the GET method.

In response to the above request, the cellular-phone-dedicated WWW server 50 activates lib-game.cgi and configures a first page of the game list (step Sb19), and transmits the page to the cellular phone 10 (step Sb20).

Upon receipt of data of the first page of the game list, the cellular phone 10 interprets the data and displays the first page of the game list on the LCD 111 (step Sb21). As shown in FIG. 21E, the page displayed in this step lists titles of various games. Here, the user is assumed to have selected the title “drops” shown in FIG. 21E. In some cases, the game list is composed of a plurality of pages rather than a single page. In this case, the user can select a “next” button shown in FIG. 21E. In response thereto, a request including the character string “(scheme)://www-p.techfirm.co.jp/cgi-bin/lib-game.cgi?id=10000&page2” (scheme is “http:”, for example) is transmitted from the cellular phone 10 to the cellular-phone-dedicated WWW server 50, whereby a second page of the game list is provided. As described above, when the last portion of the request URI includes “pageN”, the N-th page of the game list is provided.

According to the above selection operation, the cellular phone 10 transmits to the cellular phone-dedicated WWW server 50 a request for a description for the game “drops” (step Sb22). This request includes the character string “(scheme)://www-p.techfirm.co.jp/cgi-bin/expl.cgi?id=10000&app=56789.” (scheme is “http:”, for example) In the character string, “app=56789” represents an application ID allocated to the game “drops.”

In response to the above request, the cellular-phone-dedicated WWW server 50 activates expl.cgi, thereby configures a description page for the game “drops” (step Sb23), and transmits the page to the cellular phone 10 (step Sb24). To configure the description page, the cellular-phone-dedicated WWW server 50 obtains a description and a capture file for the specified applet by reference to the application-registration master table AST in the database server 54 and configures the description page on the basis of the thus-obtained description and capture file.

Upon receipt of data of the description page, the cellular phone 10 interprets the data and displays the description page on the LCD 111 (step Sb25). As shown in FIG. 21F, the page displayed in this step includes a description for explaining the contents of the game “drops” and buttons for selecting one of various operations, such as downloading, displaying how to use, and displaying screen capture.

The user reads the description. When the user desires to download the game to the cellular phone 10, the user selects “download” shown in FIG. 21F.

In response to the selecting operation, the cellular phone 10 transmits to the cellular-phone-dedicated WWW server 50 a request for downloading “drops” to the cellular phone 10 (step Sb26). The aforementioned request includes the character string “(scheme)://www-c.techfirm.co.jp/56789/dl.cgi?id=10000” (scheme is “http:”, for example) specified by the GET method.

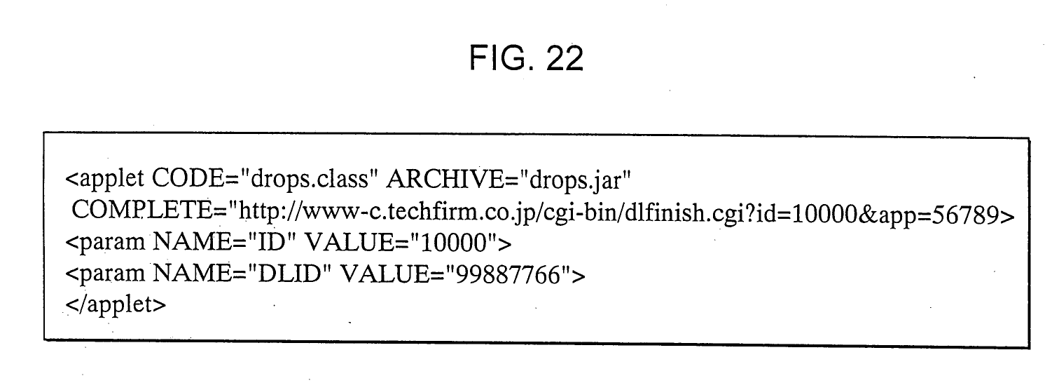

In response, the cellular-phone-dedicated WWW server 50 activates dl.cgi and configures download-dedicated HTML data prepared corresponding to the game “drops” (step Sb27), and transmits the HTML data to the cellular phone 10 (step Sb28). The download-dedicated HTML data is configured as shown in FIG. 22. From the download-dedicated HTML data that has been received, the cellular phone 10 detects an “applet” tag (step Sb29). Then, the cellular phone 10 transmits to the cellular-phone-dedicated WWW server 50 a request for fetching the JAR file specified by the “ARCHIVE” tag (step Sb30).

The aforementioned request includes the character string “(scheme)://www-c.techfirm.co.jp/56789drops.jar” (scheme is “http:”, for example) specified by the GET method.

In response to the aforementioned request, the cellular-phone-dedicated WWW server 50 fetches the JAR file indicated by the filename “drops.jar” (step Sb31). Subsequently, the cellular-phone-dedicated WWW server 50 transmits the fetched file to the cellular phone 10 (step Sb32).

The cellular phone 10 receives the JAR file and writes it into the SRAM 104 (step Sb33). Upon completion of receipt of the JAR file, the cellular phone 10 transmits a request signal indicating completion of downloading, to a URL specified by “COMPLETE” tag in the aforementioned HTML data (step Sb34). The transmitted request includes the character string “(scheme)://www-c.techfirm.co.jp/cgi-bin/dlfinish.cgi?id=10000&app=56789&DLID=99887766” (scheme is “http”, for example) specified by the GET method. Concurrently, upon completion of receipt of the JAR file, the cellular phone 10 stores, in a predetermined storage area in the SRAM 124, a class which is specified by a “CODE” tag in FIG. 22 and is executed first upon startup of the applet, the parameters of which are specified by “param” tags and which the applet can refer to during execution thereof. Further, the host name “game.techfirm.co.jp” of a server from which the JAR file has been obtained is stored in the predetermined storage area. Due to a restriction imposed on the downloaded applet by the Java virtual machine JVM, the cellular phone 10 is permitted to communicate only with the server (host name: “game.techfirm.co.jp”) from which the JAR file has been obtained.

Among the parameters specified in the “param” tags, which are stored in the cellular phone 10, the parameter “ID” is used to identify the user who effects communication with the cellular phone-dedicated WWW server 50. The parameter “DLID” is issued so as to be unique each time data for downloading are created. As described below, when the cellular-phone-dedicated WWW server 50 communicates with an application on the cellular phone 10, the parameter “DLID” is used to check whether the application has been obtained properly.

In response to the aforementioned request, the cellular-phone-dedicated WWW server 50 activates dlfinish.cgi so as to access the database server 54. Then, the cellular-phone-dedicated WWW server 50 increments by one the download count value corresponding to the combination of user ID “10000” and application ID “56789” in the user-access preservation table UAT. Further, the cellular-phone-dedicated WWW server 50 writes download date, etc., in the download-ID management table DIT and the last-download management table LDT (step Sb35). Specifically, the cellular phone-dedicated WWW server 50 stores the “DLID,” the “application ID,” and the “user ID” in a set in the above-described downloaded-ID management table DIT. In addition, when the cellular-phone-dedicated WWW server 50 receives data from an application running on the cellular phone 10, the cellular-phone-dedicated WWW server 50 receives the three aforementioned data items together as a group. This enables the cellular-phone-dedicated WWW server 50 to judge whether a transmission source of the received data is the authorized application that the cellular-phone-dedicated WWW server 50 itself has downloaded to the cellular phone 10. This judgment is effected through comparison between the three data items received from the cellular phone 10 and those stored in the download management table. Thus, the above-described mechanism can prevent other terminals or unauthorized applications from modifying the internal data and from entering the system as an authorized application.

Subsequently, the cellular-phone-dedicated WWW server 50 generates an OK message indicating completion of all the download processing, and transmits the message to the cellular phone 10 (step Sb36).

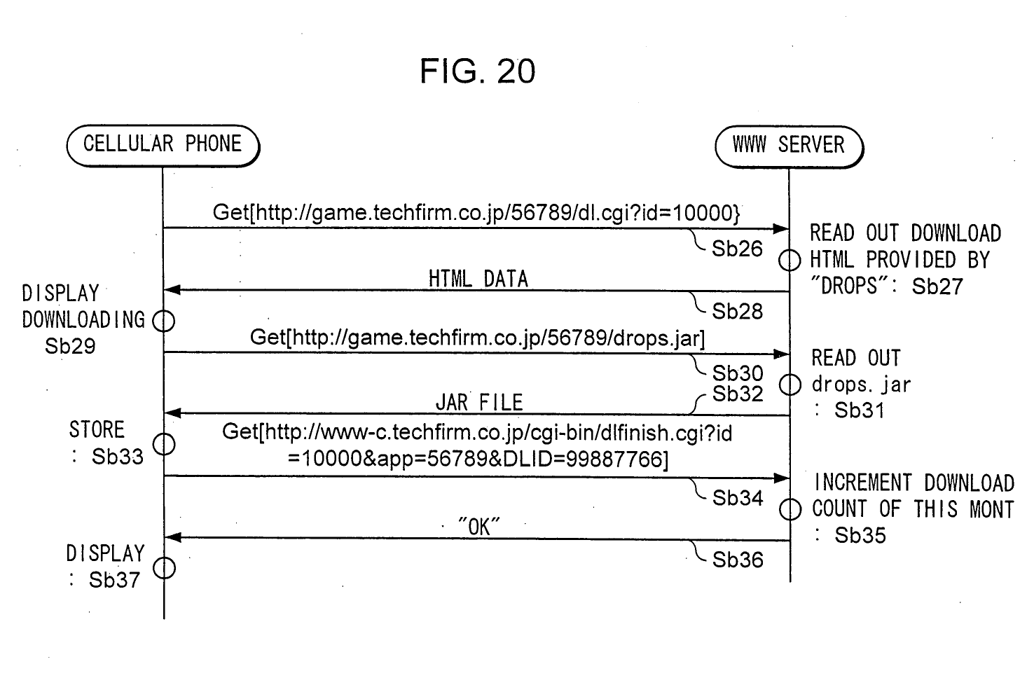

Upon receipt of data of the aforementioned message, the cellular phone 10 interprets the data and displays the message on the LCD 111 (step Sb37). Subsequently, the cellular phone 10 ends the processing shown in FIG. 20.

(3) Applet Execution

Herein below, applet execution processing will be described.

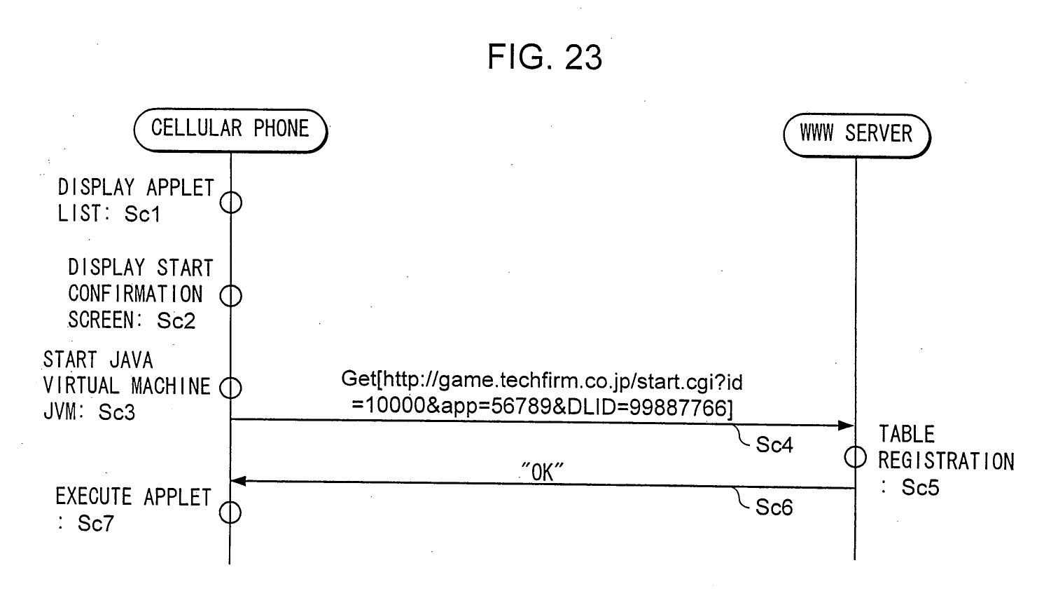

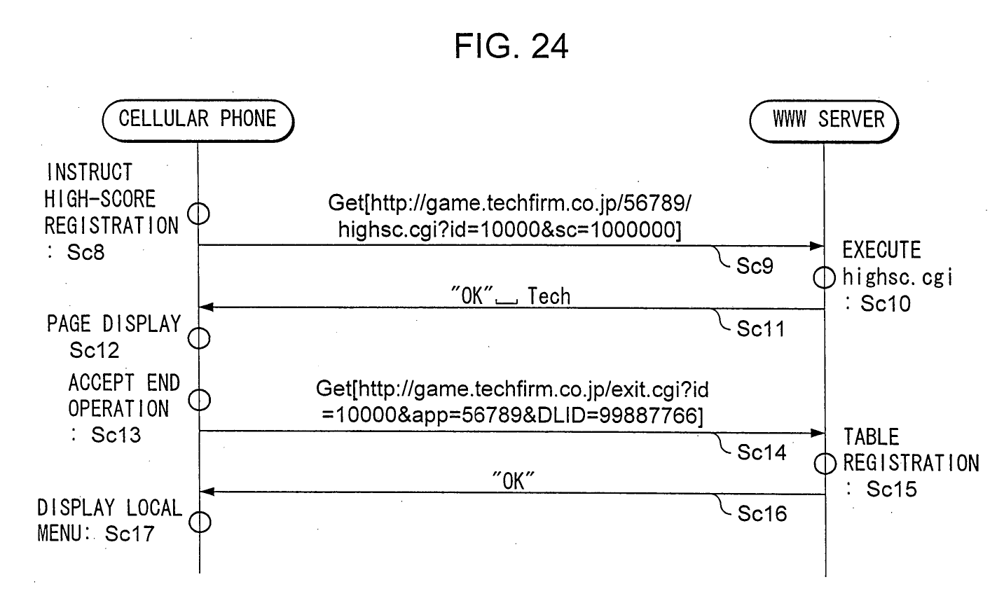

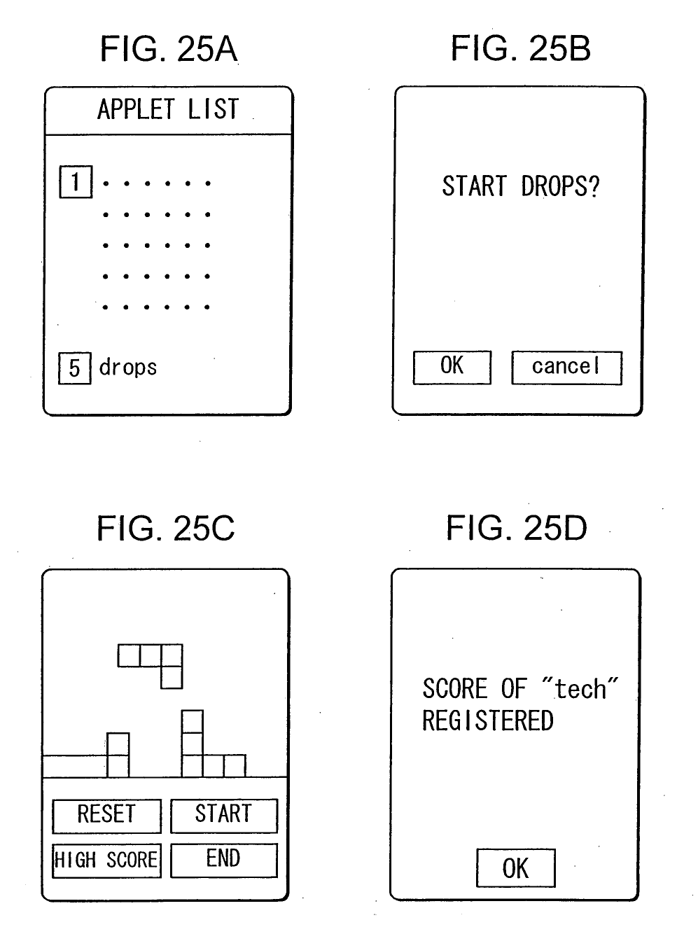

FIGS. 23 and 24 are sequence diagrams showing the operations of the cellular phone 10 and the cellular-phone-dedicated WWW server 50 during applet execution. FIGS. 25A to 25D show example screens that are displayed on the LCD 111 of the cellular phone 10 during the applet execution operation.

As shown in FIG. 23, first, the user operates the cellular phone 10 to read a list of downloaded applets from the SRAM 124 and display the list on the LCD 111 (step Sc1). The applet list displayed in this step has a configuration, as shown in FIG. 25A, in which the names of the downloaded applets are listed.

When the user selects the “drops” button shown in FIG. 25A, the cellular phone 10 changes the display of the LCD 111 in order to display a screen shown in FIG. 25B, thereby displaying a message for inquiring the user whether to start the selected applet (step Sc2).

When the user selects “OK” on the screen of FIG. 25B, the cellular phone 10 starts the Java virtual machine JVM and designates a class “drops.class” to be executed first (step Sc3).

Subsequently, the cellular phone 10 sends to the cellular-phone-dedicated WWW server 50 a request for notifying activation of the applet (step Sc4). As shown in FIG. 23, this request includes the character string “(scheme)://game.techfirm.co.jp/start.cgi?id=10000&app=56789&DLID=99887766” (scheme is “http:”, for example) specified by the GET method. As described above, in order to check the validity of communications between the cellular-phone-dedicated WWW server 50 and the application on the cellular phone 10, “DLID=99887766” indicating the download ID, “app=56789” indicating the application ID, and “id=10000” indicating the user ID are included in the above-described request.

Having received the aforementioned request, the cellular phone-dedicated WWW server 50 activates start.cgi in order to judge whether the combination of the download ID, the application ID, and the user ID is a valid combination, by reference to the download-ID table DIT in the database server 54. Subsequently, the cellular-phone-dedicated WWW server 50 increments by one the activation count in the user-access storing table UAT corresponding to the combination of user ID “id=10000” and application ID “app=56789.” Further, the cellular-phone-dedicated WWW server 50 writes last-activation date and time in the last-activation date/time storing table LRT corresponding to the combination of user ID “id=10000” and application ID “app=56789” (step Sc5).

Subsequently, the cellular-phone-dedicated WWW server 50 generates an OK message indicating that applet activation has been approved and transmits the message to the cellular phone 10 (step Sc6).

In response to this notice, the cellular phone 10 executes the applet for the game “drops” (step Sc7). FIG. 25 C shows an example screen of the LCD 111 of the cellular phone 10 displayed during the execution of the applet.

When the user ends the game with a score higher than his previous highest score, the user can register the new high score. This registration processing is started when the user selects a “high score” button (not illustrated) on a game end screen (step Sc8).

First, the cellular phone 10 sends to the cellular-phone-dedicated WWW server 50 a request for registration of the high score (step Sc9). As shown in FIG. 24, this request includes the character string “(scheme)://game.techfirm.co.jp/56789/highsc.cgi?id=10000&sc=12256000” (scheme is “http:”, for example) specified by the GET method. In the character string, “sc=12256000” means that the score is 12256000.

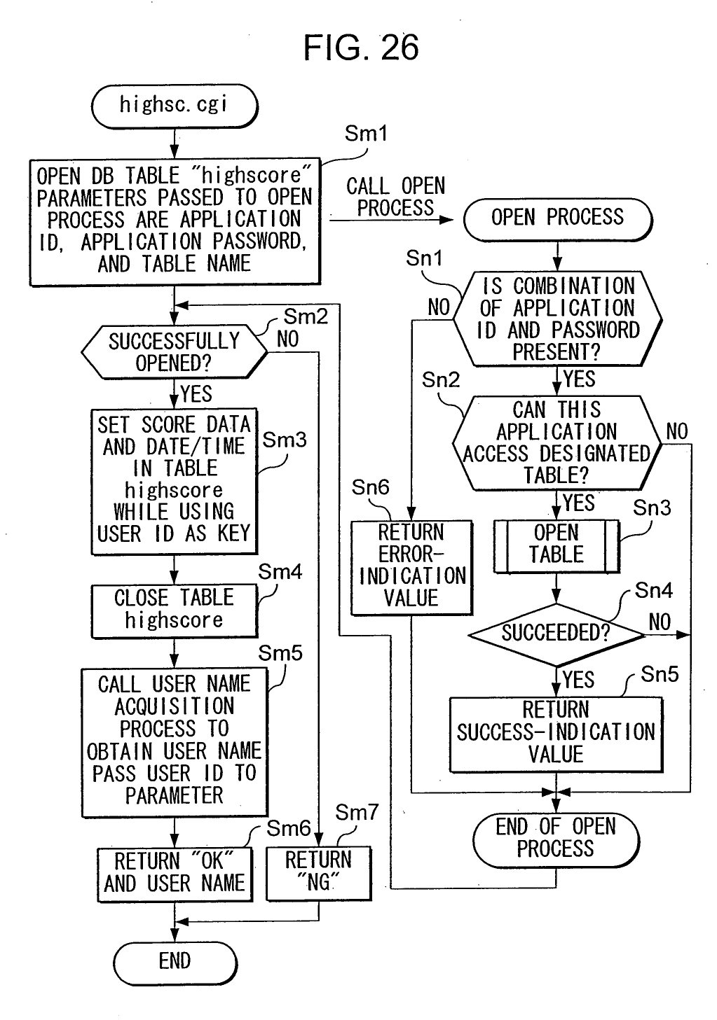

In response to the aforementioned request, the cellular-phone-dedicated WWW server 50 activates highsc.cgi in order to register the designated score into a high-score table (not illustrated)in the database server 54. After completion of the high-score registration processing, the cellular-phone-dedicated WWW server 50 generates an OK message indicating completion of the high-score registration processing and obtains a user name “Tech” (step Sc10). The details of these processing operations will be described later with reference to the flowchart shown in FIG. 26.

The cellular-phone-dedicated WWW server 50 transmits the OK message and the user name to the cellular phone 10 (step Sc11).

Upon receipt of data of the OK message and the user name, the cellular phone 10 interprets the data and displays a screen as shown in FIG. 25D (step Sc12). When the user selects “OK” on this screen, the originally-displayed game screen is displayed on the LCD 111.

When the user performs an operation for ending the game, the cellular phone 10 accepts the operation (step Sc13) and sends to the cellular-phone-dedicated WWW server 50 a request for requesting applet ending (step Sc14). As shown in FIG. 24, this request includes the character string “(scheme)://game.techfirm.co.jp/56789/exit.cgi?id=1000&app=56799&DLID99887766” (scheme is “http”, for example) specified by the GET method.

The cellular-phone-dedicated WWW server 50 activates exit.cgi in order to perform the following processing. After checking the validity of the combination of “DLID=99887766” indicating the download ID, “app=56789” indicating the application ID, and “id=10000” indicating the user ID in the same manner as described above, the cellular-phone-dedicated WWW server 50 calculates the difference between the time when the user (whose ID is 10000) started the application (whose ID is 56789) and the time when the request for ending the applet was received; i.e., an applet execution time, by reference to the last-activation date/time storing table LRT. Subsequently, the cellular-phone-dedicated WWW server 50 registers the applet execution time in the user-access storing table UAT such that the applet execution time is related to the user ID “10000” and the application ID “56789” (step Sc15).

Subsequently, the cellular-phone-dedicated WWW server 50 generates an OK message indicating completion of the processing, and transmits the message to the cellular phone 10 (step Sc16).

Upon receipt of the message, the cellular phone 10 returns to the original state in which its local menu is displayed (step Sc17) and ends the processing shown in FIG. 24.

(4) High-Score Registration Processing

Next, the above-described high-score registration processing will be described in detail with reference to the flowchart shown in FIG. 26.

When highsc.cgi is started in the above-described manner, the cellular-phone-dedicated WWW server 50 sets parameters for performing an opening process for opening a high-score table (step Sm1). Specifically, various parameters such as application ID, application password, and table name are set. “Application password” refers to a password which has been issued in advance to the corresponding provider and is defined in the code of highsc.cgi. “Table name” refers to the name of a table to be opened and in the present embodiment is “highscore.”

Subsequently, a process for opening the designated table is called, and the processing proceeds to step Sn1. In step Sn1, among the set parameters, the application ID and the application password are extracted, and the validity of the combination of the application ID and the application password is judged (step Sn1).

When the combination is judged to be valid (step Sn1; Yes), by reference to the application-access management table AAT, a judgment is made as to whether the application indicated by the application ID is permitted to access the high-score table (step Sn2).

When access is permitted, the high-score table is opened (step Sn3), and when the table has been opened successfully (step Sn4; Yes), a message indicating that the opening process has succeeded in opening the high-score table is returned to highsc.cgi (step Sn5).

Upon receipt of the message indicating that the opening process has succeeded in opening the high-score table (step Sm2), the score and the related date and time are registered in the high-score table such that they are related to the user ID (step Sm3).

Subsequently, the high-score table is closed (step Sm6), and then a user-name acquisition process is called in order to obtain the user name (step Sm5). This user-name acquisition process is executed in a manner similar to the above-described case of a high-score table opening process.

When the user name has been obtained, the cellular-phone-dedicated WWW server 50 transmits to the cellular phone 10 an OK message and the user name as described above.

Usually, since an applet is permitted to communicate only with a server from which the applet has been downloaded, a plurality of applets share a single server. Therefore, there arises a problem in relation to inter-application access management. However, when access areas are controlled exclusively by the respective applications as described above, a high degree of safety in relation to access can be secured. Further, for data, such as data regarding users, which are used by various applications and for which protection of privacy is important, the server provides a common application interface for access of such data. Provision of such an interface eliminates waste of data and improves the security of private data.

(5) Point Voting

Next, point voting processing will be described.

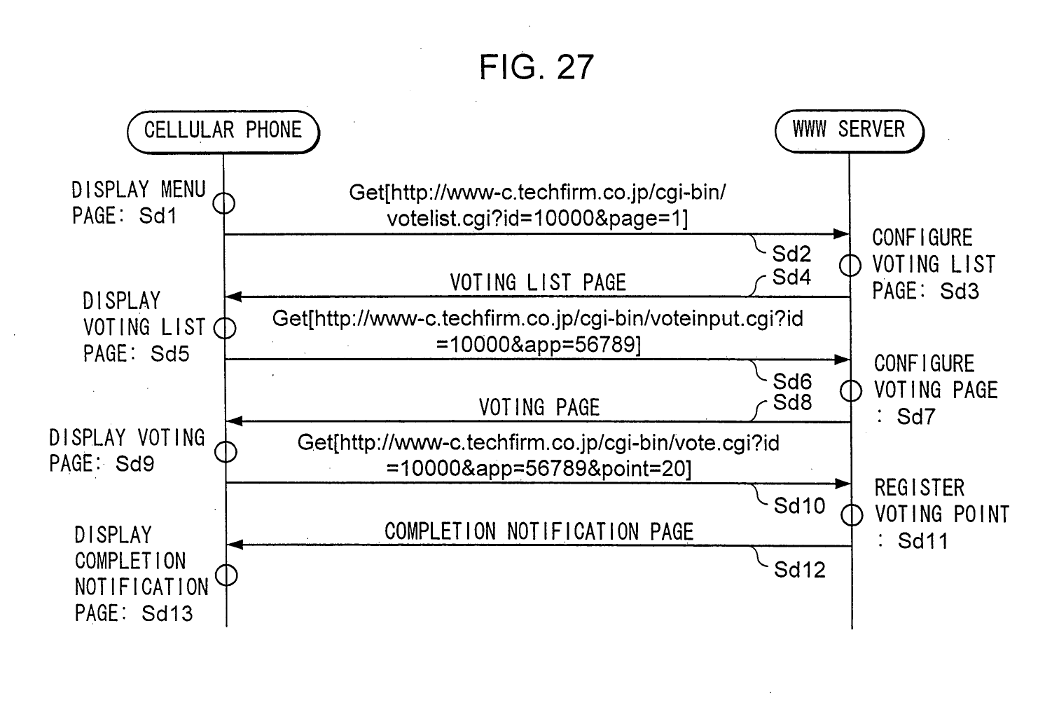

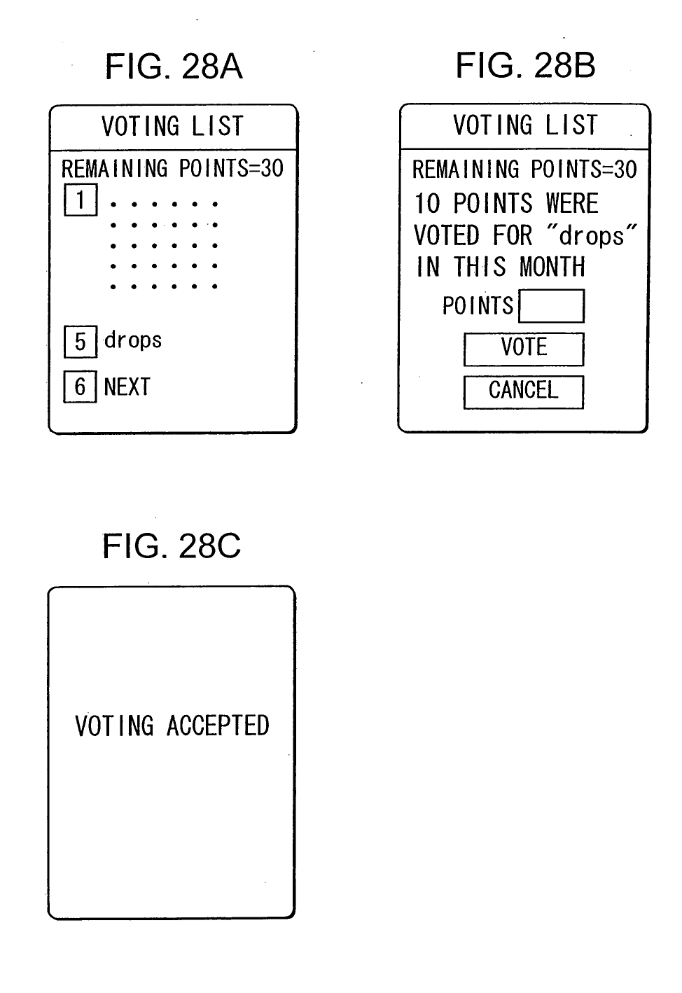

FIG. 27 is a sequence diagram showing the operations of the cellular phone 10 and the cellular-phone-dedicated WWW server 50 during point voting. FIG. 28A to 28C show example screens that are displayed on the LCD 111 of the cellular phone 10 during the point-voting operation.

As shown in FIG. 27, as in the case of the above-described applet downloading, the user operates the cellular phone 10 in order to start the browser. After authentication on the basis of the password, etc., the cellular phone 10 receives a menu page from the cellular-phone-dedicated WWW server 50 and displays it (step Sd1). As shown in FIG. 21C, the page displayed in this step includes a list of menu items.

When the user wishes to use the point-voting service, the user simply clicks a “voting” button shown in FIG. 21C. In response to the click operation, the cellular phone 10 transmits to the cellular-phone-dedicated WWW server 50 a request for a voting list page (step Sd2). This request includes the character string “(scheme)://www-c.techfirm.co.jp/cgi-bin/votelist.cgi?id=10000&page=1” (scheme is “http:”, for example) specified by the GET method.

In response to the above request, the cellular-phone-dedicated WWW server 50 activates votelist.cgi and configures a voting list page (step Sd3). Specifically, the cellular phone-dedicated WWW server 50 accesses the database server 54 to thereby refer to the last-activation date/time storing table LRT, the last-download management table LDT, and the user-access storing table UAT. By reference to these tables, the cellular-phone-dedicated WWW server 50 extracts all the application IDs of applets which the user indicated by user ID “10000” downloaded last, activated last, executed last within the last three months or for which the user has voted within the last three months. Subsequently, the cellular-phone-dedicated WWW server 50 obtains points with which the user can vote at the present and constitutes a list for displaying them. The list may be divided into a plurality of pages in order to display all the data. An upper limit is set for points with which one user can vote within a predetermined period. Here, it is assumed that each person can vote with 70 points each month. When the user-access management table UAT shown in FIG. 11 is referred to under this assumption, it is found that the user can vote with 30 points within the remaining period of this month (June, 2000), because the user has already voted with 40 points in total.

The cellular-phone-dedicated WWW server 50 transmits the thus-constituted list page to the cellular phone 10 (step Sd4).

Upon receipt of data of the list page, the cellular phone 10 interprets the data and displays the list page on the LCD 111 (step Sd5). As shown in FIG. 28A, the list page displayed in this step includes the number of voting points, and a list of applets for which the user can vote. Here, the user is assumed to have selected a “drops” button shown in FIG. 28A in order to vote for the applet.

In response to the selection operation, the cellular phone 10 transmits to the cellular-phone-dedicated WWW server 50 a request for a voting page (step Sd6). This request includes the character string “(scheme)://www-c.techfirm.co.jp/cgi-bin/voteinput.cgi?id=10000&app56789” (scheme is “http:”, for example) specified by the GET method.

In response to the above request, the cellular-phone-dedicated WWW server 50 activates voteinput.cgi and configures a voting page (step Sd7). That is, by reference to the user-access management table UAT, the cellular-phone-dedicated WWW server 50 obtains the number of points with which the user (user ID: 10000) has voted this month for the application “56789” designated by the user. Subsequently, the cellular-phone-dedicated WWW server 50 configures the page including an input field for point input.

Subsequently, the cellular-phone-dedicated WWW server 50 transmits the configured voting page to the cellular phone 10 (step Sd8).

Upon receipt of data of the voting page, the cellular phone 10 interprets the data and displays the voting page on the LCD 111 (step Sd9). As shown in FIG. 28B, in the voting page are displayed a point number, which represents the number of points “30 points” with which the user can vote for the remainder of this month, a point number “10 points” with which the user has already voted this month for “drops,” and a field for point input. Here, the user is assumed to have input “20” points in the input field shown in FIG. 28B and selected the “voting” button shown in FIG. 28B. When the user selects the “cancel” button, the cellular phone 10 cancels the operation performed up to the present, and returns to the menu page.

In response to the above selection operation, the cellular phone 10 transmits to the cellular-phone-dedicated WWW server 50 a request for performing point voting for “drops” (step Sd10). The request includes the character string “(scheme)://www-c.techfirm.co.jp/cgi-bin/vote.cgi?id=10000&app=56789&point=20” (scheme is “http:”, for example) specified by the GET method. Here, “point=20” means that a number of points with which the user votes this time is 20 points.

In response to the above request, the-cellular phone-dedicated WWW server 50 activates vote.cgi in order to register the voted points into the database server 54 (step Sd11). Specifically, the cellular-phone-dedicated WWW server 50 accesses the user-access storing table UAT in the database server 54 and adds “20 points” input this time to the number of points this month “10 points” of the application ID “56789” designated by the user (user ID=10000) in order to store “30 points” in place of “10 points.” Notably, before storage, it is checked whether the number of points input by the user exceeds the upper limit of points or a number of points with which the user can vote this month.

Subsequently, the cellular-phone-dedicated WWW server 50 generates a completion notification page for reporting completion of the processing and transmits it to the cellular phone 10 (step Sd12). If the number of points input by the user exceeds the upper limit, the cellular-phone-dedicated WWW server 50 configures a page for displaying an error screen and transmits it to the cellular phone 10.

Upon receipt of data of the completion notification page, the cellular phone 10 interprets the data and displays on the LCD 111 a screen as shown in FIG. 28C (step Sd13). Subsequently, the processing shown in FIG. 27 is concluded.

As described above, a limit is set for the number of points with which the user can vote within a predetermined period, and point voting is performed only for applications which the user has used recently. Therefore, unfair conduct such that the user intentionally votes with points for a specific application can be ruled out.

(6) Calculation of License Fee

Next, the calculation of a license fee to be paid to each provider, which is performed by the totaling server 55 will be described. Methods for calculating license fees are divided into two general methods, and these two methods will be described in turn.

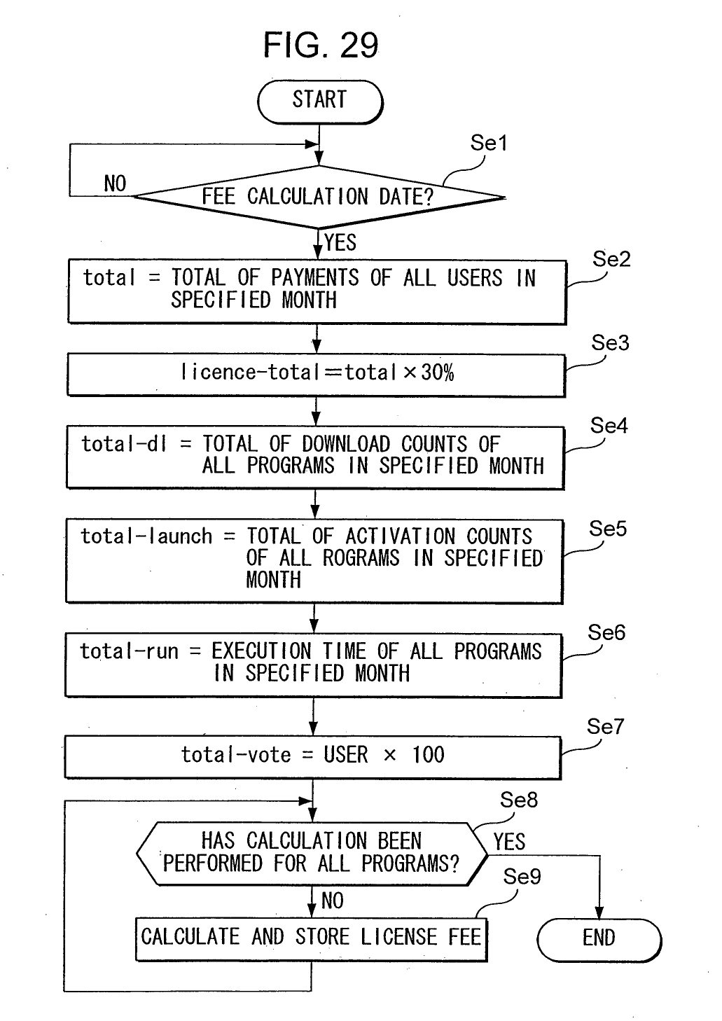

FIG. 29 is a flowchart showing operation of the totaling server 55 for calculating license fees in accordance with the first method.

This license fee calculation is executed for each unit calculation period of a predetermined length; e.g., every month or every six months. In the present embodiment, the calculation period is one month, and the license fee calculation is performed on the last day of the month.

By reference to a timer (not illustrated), the totaling server 55 judges whether it is the fee calculation day. (step Se1).

This processing in step Se1 is repeated (step Se1; No) until the fee calculation day, and when it is the fee calculation day (step Se1; Yes), processing proceeds to step Se2.

By reference to the user-payment management table UPT within the database server 54, the totaling server 55 calculates the sum of usage fees paid by all users within a specified calculation period (step Se2).

A portion of the sum of the usage fees is paid to the corresponding provider as a license fee, and the remaining portion becomes a profit for the manager of the group of servers 5. A predetermined fixed portion of the sum of the usage fees is paid to the corresponding provider, and in the present embodiment the fixed portion is set to 30%. Therefore, the totaling server 55 multiplies the sum of the usage fees calculated in step Se1 by 0.3 (30%) to thereby calculate an amount of money “license-total” that can be allotted to license fee payment (step Se3). In an example case in which the sum of the usage fees calculated in step Se1 is 1,000,000 yen, the license-total that can be allotted to license fee payment is 300,000 yen.

Next, by reference to the user-access storing table UAT in the database server 54, the totaling server 55 extracts the download counts of all the applications within the calculation period and calculates a value “total-dl,” which is the sum of the download counts of all the applications (step Se4). In an example case in which the calculation for “June” is performed by reference to the user-access storing table UAT shown in FIG. 11, “2,” “3,” and “2” are extracted as download counts, so that the sum of these values; i.e., total-dl, becomes “7.” Subsequently, by reference to the user-access storing table UAT, the totaling server 55 extracts the activation counts of all the applications within the calculation period and calculates a value “total-launch,” which is the sum of the activation counts of all the applications (step Se5). In the example case in which the calculation for “June” is performed by reference to the user-access storing table UAT shown in FIG. 11, “5,” “8,” and “9” are extracted as activation counts, so that the sum of these values; i.e., total-launch, becomes “22.”

Next, by reference to the user-access storing table UAT, the totaling server 55 extracts the execution-time count of all the applications within the calculation period and calculates a value “total-run,” which is the sum of the execution times of all the applications (step Se6). For example, when the calculation for “June” is performed by reference to the user-access storing table UAT shown in FIG. 11, “23 (min),” “40 (min),” and “38 (min)” are extracted as execution times, so that the sum of these values; i.e., total-run, becomes “101 (min).”

Next, by reference to the user-access storing table UAT, the totaling server 55 extracts the point numbers of all the applications within the calculation period and calculates a value “total-point” which is the sum of the point numbers of all the applications (step Se7). In the example case in which the calculation for “June” is performed by reference to the user-access storing table UAT shown in FIG. 11, “30,” “60,” and “0” are extracted as point numbers, so that the sum of these values; i.e., total-point, becomes “90.”

In the following calculation processing, a license fee is successively calculated on an application-by-application basis. Therefore, a judgment is made as to whether the calculation has been completed for all the applications (step Se8). When it is judged that the calculation has not been completed for all the applications (step Se8; No), processing proceeds to step Se9.

In step Se9, for a specific application (e.g., an application whose ID is “56789”), the totaling server 55 calculates a “license-fee” to be paid to the provider of the application.

This calculation is performed in accordance with the following calculation formula F1.
license-fee={(“the download count of the specific application in the specified month”÷total-dl)×Rd+(“the activation count of the specific application in the specified month”÷total-launch)×Rr+(“the execution time of the specific application in the specified month”÷total-run)×Rr+(“the number of points for the specific application obtained in the specified month”÷total-point)×Rp}×total-license (amount of money that can be allotted to payment of license fee) (F1)

In formula F1, Rd, Rl, Rr, and Rp are weighting parameters which are allotted to the download count, the activation count, the execution time, and the number of points during the license fee calculation. These parameters satisfy the relationships Rd≧0, Rl≧0, Rr≧0, Rp≧0, and Rd+Rl+Rr+Rp=1.

A calculation example will be described for an example case in which Rd=0.2, Rl=0.3, Rr=0.35, and Rp=0.15.

As described above, total-license=300,000 yen, total-dl=7, total-launch=22, total-run=101, and total-point=90. Further, as shown in the user-access storing table UAT, the “download count of the specific application” (application ID: 56789, the below described application has the same application ID) is “4”; the “activation count of the specific application within the specified month” is “14”; the “execution time of the specific application within the specified month” is “61 (min)”, and the “number of points for the specific application within the specified month” is “30.” Therefore, through substitution of these values in formula F1, the license-fee is calculated to be about 167,000.

The above-described calculation is performed for each application. When the calculation has been completed for all the applications (step Se8; Yes), the processing shown in FIG. 29 is ended.

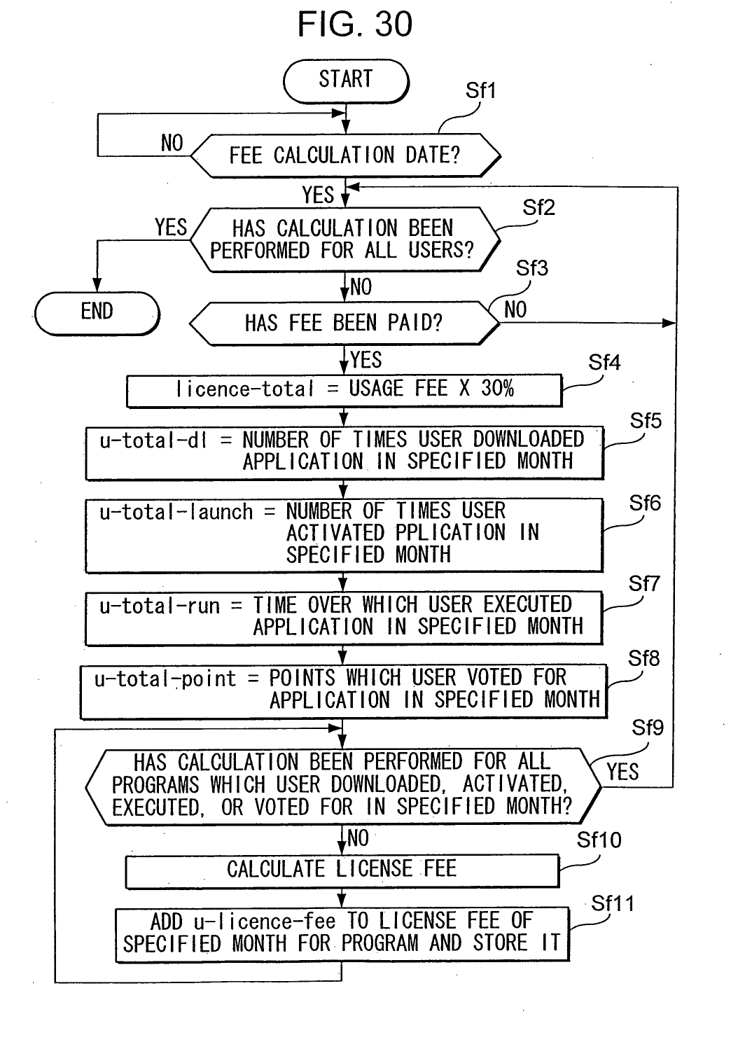

FIG. 30 is a flowchart showing operation of the totaling server 55 for calculating license fees in accordance with the second method.

Unlike the above-described first method in which processing is executed on an application-by-application basis, in the license fee calculation according to the second method, processing is executed on a user-by-user basis.

First, by reference to a timer (not illustrated), the totaling server 55 judges whether it is the fee calculation day (step Sf1).

This processing in step Sf1 is repeated (step Sf1; No) until the fee calculation day, and when it is the fee calculation day (step Se1; Yes), processing proceeds to step Sf2.

In the following processing, license fee calculation is performed on a user-by-user basis. Therefore, a judgment is made as to whether the calculation has been completed for all users. When it is judged that the calculation has not been completed for all the applications (step Sf2; No), processing proceeds to step Sf3.

In step Sf3, for a specific user (for e.g., a user whose ID is “10000”), the totaling server 55 judges whether the user has paid a usage fee for a specified month, with reference to the user-payment management table UPT.

When the usage fee is judged not to have been paid (step Sf3; No), processing returns to step Sf2, and the same processing is performed for a different user.

When the usage fee is judged to have been paid (step Sf3; Yes), processing proceeds to step Sf4.

In step Sf4, the totaling server 55 multiplies the usage fee which the user paid in the specified month by 0.3 (30%) to thereby calculate a value “u-license-total,” which represents a license fee that can be derived from the usage fee of a single user.

Next, with reference to the user-access storing table UAT in the database server 54, the totaling server 55 calculates a value “u-total-dl,” which represents the total number of times the user whose user ID is 10000 downloaded a specific application within the specified period (step Sf5).

Subsequently, with reference to the user-access storing table UAT, the totaling server 55 calculates a value “u-total-launch,” which represents the total number of times the user whose user ID is 10000 activated the specific application within the specified period (step Sf6).

Next, with reference to the user-access storing table UAT, the totaling server 55 calculates a value “u-total-run,” which represents an execution time over which the user whose user ID is 10000 executed the specific application within the specified period (step Sf7).

Next, by reference to the user-access storing table UAT, the totaling server 55 calculates a value “total-point2,” which represents the total number of points with which the user whose user ID is 10000 voted within the specified period (step Sf8).

Subsequently, the totaling server 55 judges whether all of the download count “u-total-dl”, the activation count “u-total-launch”, the execution time “u-total-run” and the number of points “u-total-point” with respect to the user whose user ID is 10000 have been calculated for the specified calculation period (step Sf9).

Subsequently, the totaling server 55 calculates the license fee of each application used by the user whose user ID is 10000 in the specified calculation period (step Sf10).

This calculation is performed in accordance with the following calculation formula F2.
u-license-fee=(“the number of times the specified user downloaded the specific application in the specified month”÷u-total-dl)×Rd+(“the number of times the specified user activated the specific application in the specified month”÷u-total-launch)×Rl+(“the time over which the specified user executed the specific application in the specified month”÷u-total-run)×Rr+(“the number of points with which the specified user voted for the specific application in the specified month”÷u-total-point)×Rp}×u-total-license (amount of money that can be allotted to payment of license fee) (F2)

In formula F2, Rd, Rl, Rr, and Rp are parameters having the same meaning as the above-described parameters. The u-license-fee is a value which represents a ratio at which the usage fee paid by the user whose ID is 1000 is distributed to the provider of the application utilized by the user.

Subsequently, the totaling server 55 adds the calculated u-license-fee to the corresponding calculated license fee stored in the application statistics table ATT in order to replace the previously stored license fee (step Sf11), and then returns to step Sf9 in order to repeat the above-described processing until the calculations for the specified user have been completed. When the calculations for the specified user have been completed (step Sf9; Yes), the totaling server 55 returns to step Sf2 in order to perform the same processing for the next user.

After license fee calculation processing is performed for all users and for all applications in the above-described manner, the processing shown in FIG. 30 is ended.

The thus-calculated license fee is transferred to a bank account which has been registered in advance by the provider.

(7) Various Searches Performed by Providers

A provider who uploaded an application to the server group 5 can search data regarding license fee and usage status of the application through access to the database server 54, which access is made by use of the PC 21.

Next a search operation which the PC-dedicated WWW server 51 performs in accordance with a request from the provider's PC 21 will be described.

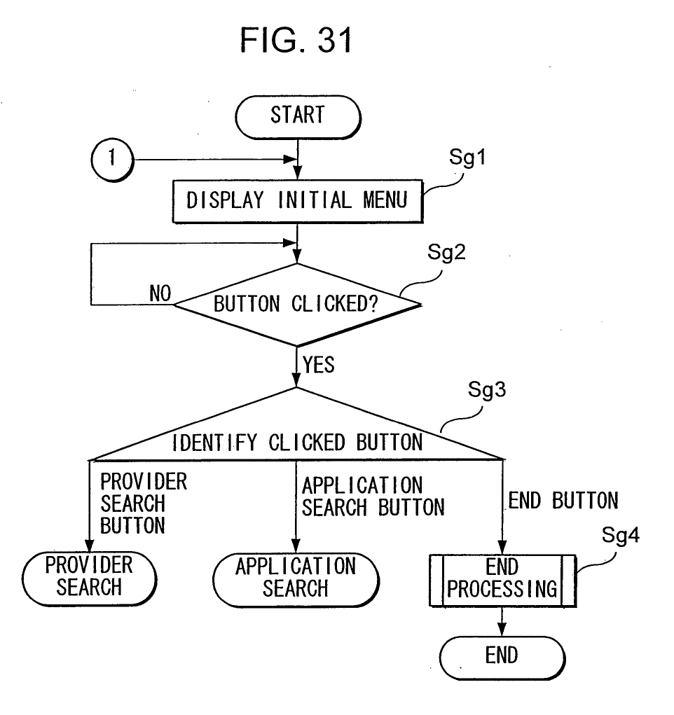

FIG. 31 is a flowchart showing the main routine executed by the PC-dedicated WWW server 51 during a search.

The processing shown in FIG. 31 is started in response to an access request from the PC 21.

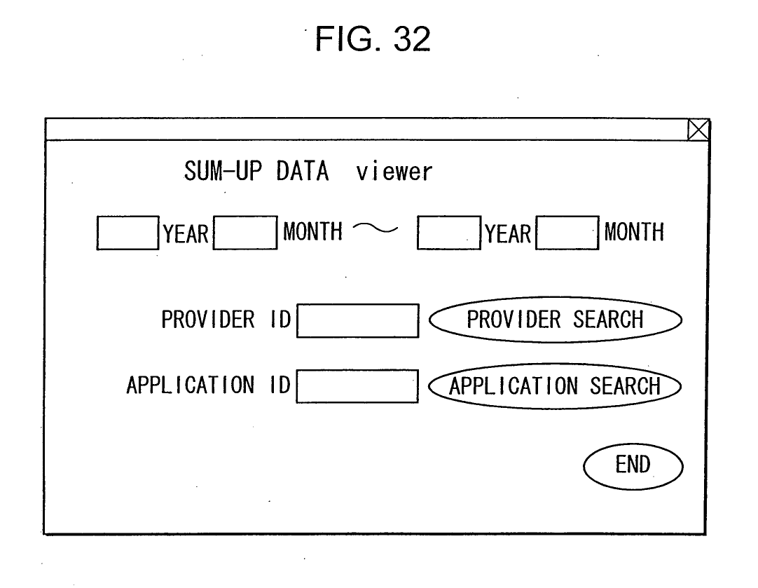

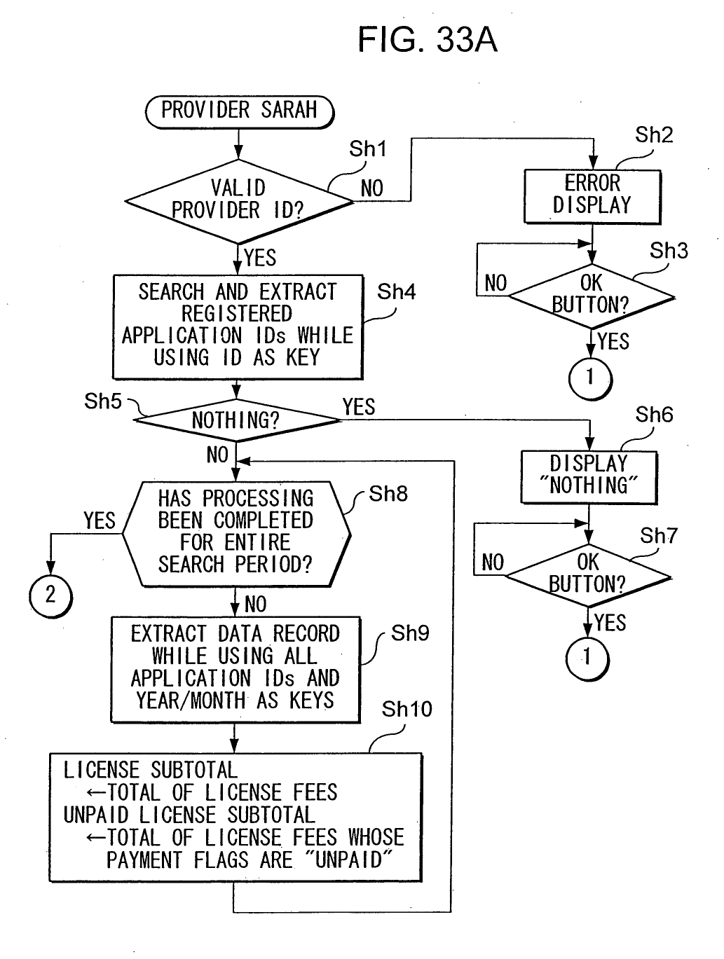

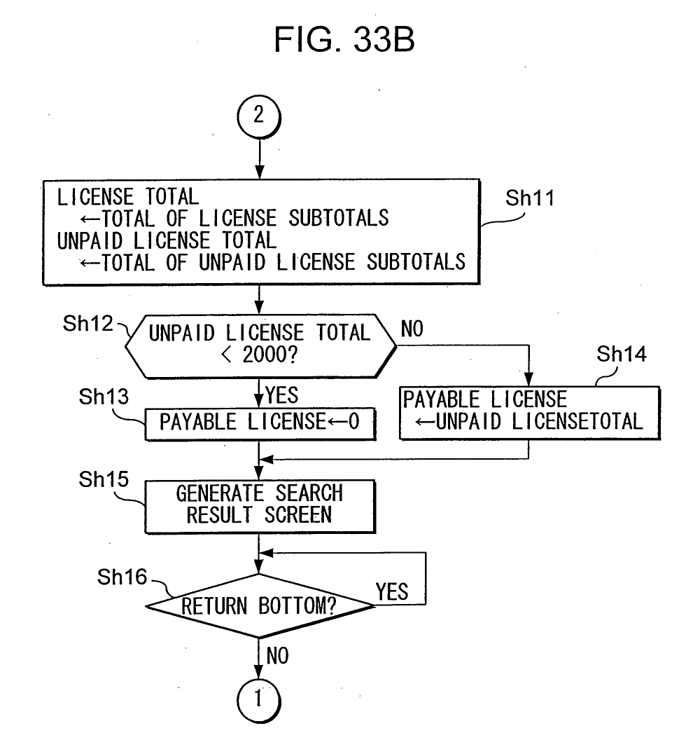

First, the PC-dedicated WWW server 51 reads data of an initial menu screen from its own hard disk device and transmits the data to the PC 21 (step Sg1). This initial menu screen has a configuration as shown in FIG. 32. The initial menu screen includes “a provider search button”, “an application search button”, “an end button”, and “fields” for inputting a search period, a provider ID, and an application ID. “Provider search” refers to a search which is performed with respect to a provider designated by a provider ID and which enables the provider for determining a license fee to be paid to the provider and an unpaid portion thereof. “Application search” refers to a search which is performed with respect to an application designated by an application ID and which enables the provider for determining a usage status of the application and a license fee corresponding to the application.

When the provider inputs a search period and an ID (provider ID or application ID) on the initial menu screen and clicks the corresponding search button, the PC-dedicated WWW server 51 detects the click operation (step Sg2; Yes) and determines which button has been clicked (step Sg3).

In accordance with the type of the clicked button, a subroutine for provider search and a subroutine for application search, which will be described later, are executed selectively. When the end button is detected to have been clicked, the PC-dedicated WWW server 51 ends the processing shown in FIG. 31, through performance of a predetermined end processing (step Sg4).

FIG(s). 33A to 33B are flowcharts/+ showing the operation of the PC-dedicated WWW server 51 during the provider search.

First, by reference to the provider master table LMT in the database server 54, the PC-dedicated WWW server 51 compares provider IDs stored in the table LMT and a provider ID input by the provider, in order to authenticate the input ID (step Sh1).

When the input ID fails to match any of the stored provider IDs (step Sh1; No), the PC-dedicated WWW server 51 transmits a predetermined error screen data to the PC 21 (step Sh2), and waits until the provider selects the “OK button” (not illustrated) on the screen of the PC 21(step Sh3). Subsequently, the PC-dedicated WWW server 51 returns to step Sg1 of the main routine.

When the input ID matches one of the stored provider IDs, the PC-dedicated WWW server 51 searches the application-registration master table AST while using the provider ID as a key, to thereby obtain all of the corresponding application IDs (step Sh4).

When no corresponding application ID has been found (step Sh5; Yes), the PC-dedicated WWW server 51 transmits to the PC 21 a message to this effect (step Sh6), and waits until the provider selects the “OK button” (not illustrated) on the screen of the PC 21(step Sh7). Subsequently, the PC-dedicated WWW server 51 returns to step Sg1 of the main routine.

When one or more corresponding application IDs have been found (step Sh5; No), among the thus-found application IDs, the PC-dedicated WWW server 51 first pays attention to a specified application ID. Subsequently, the PC-dedicated WWW server 51 searches the application statistics table ATT while using the application ID as a key to thereby extracting a corresponding license fee. Further, this license fee is classified into one of two groups depending on whether the corresponding “payment flag” in the application statistics table is set to “paid” or “unpaid” (step Sh9).

After having performed the processing in step Sh9 for all the application IDs, the PC-dedicated WWW server 51 calculates the grand total of the extracted license fees and the total of the license fees whose “payment flags” are set to “unpaid” (step Sh10). Through this calculation, the grand total of license fees and the total of unpaid license fees with respect to the specific application are obtained.

The processing in step Sh9 and Sh10 is performed for all the application IDs extracted in step Sh4. Upon confirmation of step Sh8 (Yes), processing proceeds to step Sh11.

In step Sh11, the PC-dedicated WWW server 51 calculates the sum of the license fees and the sum of the unpaid license fees which have been calculated for the respective applications over the entire search period, to thereby determine the total license fee to be paid to the provider.

Subsequently, the PC-dedicated WWW server 51 judges whether the sum of the unpaid license fees is less than a predetermined amount (step Sh12). That is, in the case in which the license fee to be paid to the provider is a very small amount and the payment is made through a financial institution such as a bank, the payment cost may become prohibitively high in relation to the license fee. In consideration of such a case, the manager of the server group 5 makes an agreement with the provider in advance such that the manager is released from payment of a license fee that is less than a predetermined amount. In the present embodiment, a minimum payable amount is set to 2,000 yen, and therefore the manager is released from payment of a license fee that is less than 2000 yen.

When the unpaid license fee is less than 2,000 yen, the PC-dedicated WWW server 51 clears the unpaid license fee.

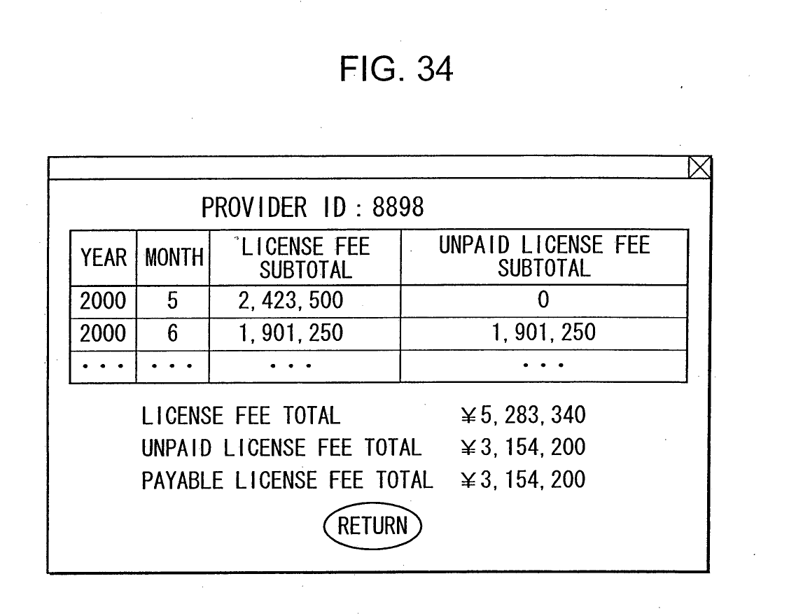

When the unpaid license fee is not less than 2,000 yen, the PC-dedicated WWW server 51 regards the unpaid license fee as an unpaid license fee to be presented to the provider (step Sh14). Subsequently, the PC-dedicated WWW server 51 generates a search result screen as shown in FIG. 34 and causes the PC 21 to display the search result screen (step Sh15). The screen of FIG. 34 shows that the provider whose provider ID is “8898” has received “2,423,500 yen” as a license fee for May, 2000 and will receive “1,901,250 yen” as a license fee for June, 2000; that the sum of license fees having been paid to the provider up to the present and license fees scheduled to be paid to the provider in the future is “5,283,340 yen”; and that the sum of unpaid license fees to be paid to the provider in the future is “3,154,200 yen.” In this case, the sum of unpaid license fees “3,154,200 yen” is also displayed as a sum of payable license fees.

When the PC-dedicated WWW server 51 detects that the provider has selected a “return” button (step Sh16; Yes), the PC-dedicated WWW server 51 returns to step Sg1 of the main routine.

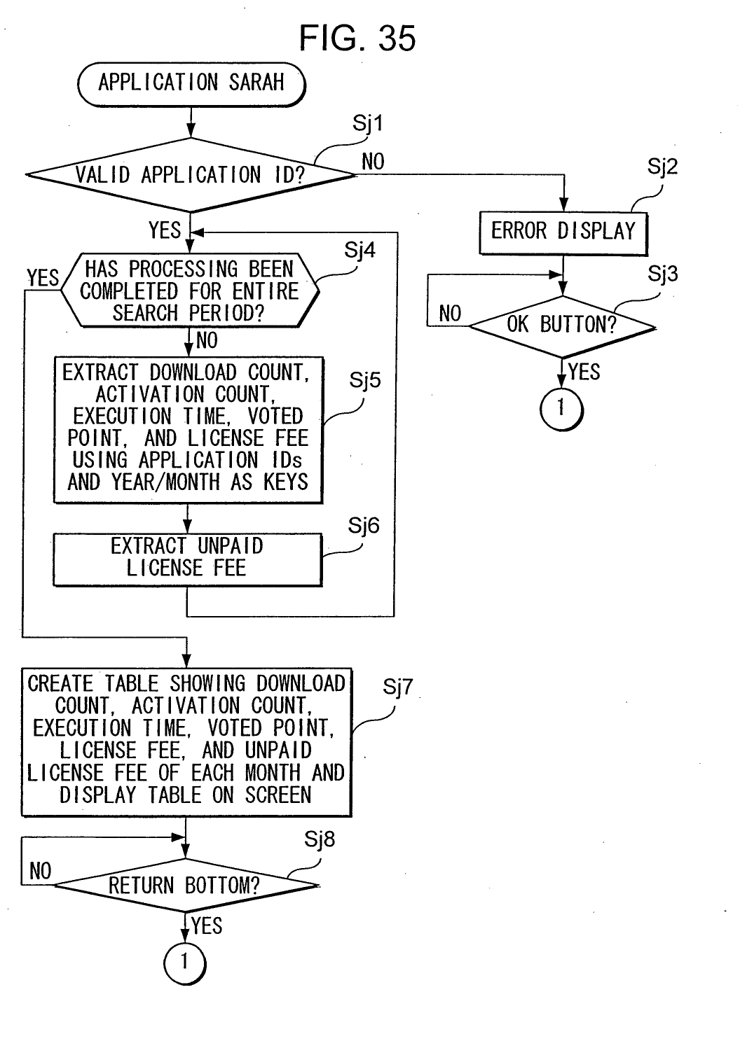

FIG. 35 is a flowchart showing the operation of the PC-dedicated WWW server 51 during the application search.

First, by reference to the application-registration master table AST in the database server 54, the PC-dedicated WWW server 51 compares application IDs stored in the table AST and an application ID input by the provider, in order to authenticate the input ID (step Sj1).

When the input ID does not match any of the stored application IDs, the PC-dedicated WWW server 51 transmits a predetermined error screen data to the PC 21 (step Sj2), and waits until the provider selects the “OK button” (not illustrated) on the screen of PC 21(step Sj3). Subsequently, PC-dedicated WWW server 51 returns to step Sg1 of the main routine.

When the input ID matches one of the stored application IDs, the PC-dedicated WWW server 51 searches the application-registration master table AST while using the application ID and months included in the search period as keys to thereby obtain corresponding download counts, activation counts, execution times, voting point numbers, and license fees (step Sj5).

Further, the PC-dedicated WWW server 51 selectively obtains license fees whose “payment flags” are set to “unpaid” (step Sj6).

The processing in steps Sj5 and Sj6 is performed over the entire designated search period. Upon confirmation that this processing has been completed (step Sj4; Yes), processing proceeds to step Sj7.

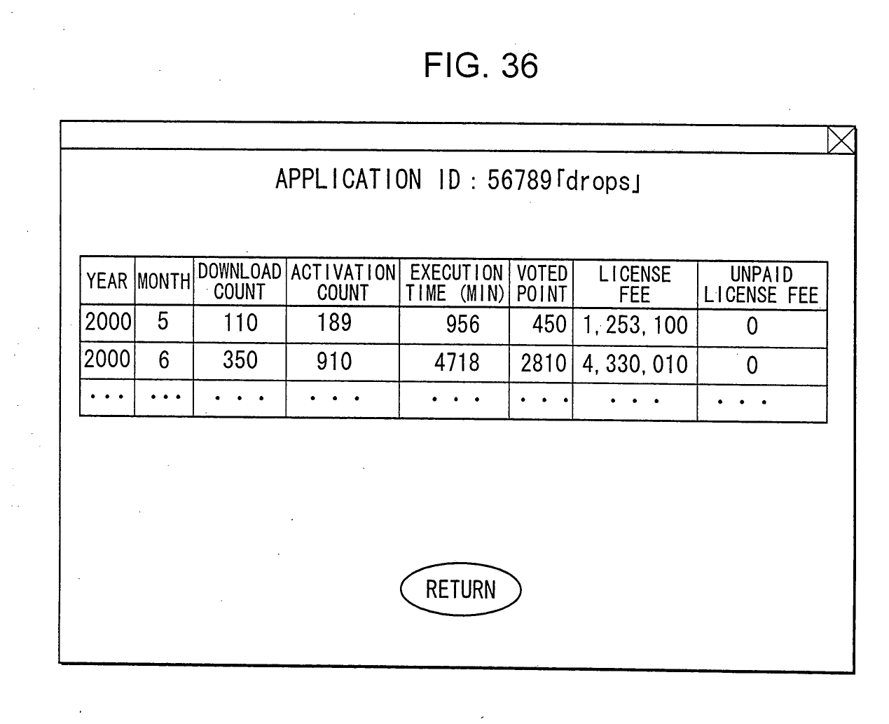

In step Sj7, the PC-dedicated WWW server 51 generates a search result screen as shown in FIG. 36 and causes the PC 21 to display the search result screen. In the screen of FIG. 36, the download count, the activation count, the execution time, the voted point number, the license fee, and the unpaid license fee in each month are displayed for the designated application. When the PC-dedicated WWW server 51 detects that the provider has selected a “return” button (step Sj8; Yes), the PC-dedicated WWW server 51 returns to step Sg1 of the main routine shown in FIG. 31.

C: Modifications

The present invention is not limited to the above-described embodiment, and various modifications are possible.

Examples of modifications will be described below. In the embodiment, download count, etc. are used as parameters for license fee distribution; however, the types of parameters are not limited thereto. Further, in the embodiment, each license fee is obtained through proportional distribution by use of various parameters; however, the method of obtaining each license fee is not limited thereto and may be performed with the addition of a different distribution method in which a basic service fee is introduced and is distributed to the providers.

In the present embodiment, the status of payment of each user is managed by use of the user-payment management table UPT. However, the method of managing payment status is not limited thereto, and it may be the case that only the total of usage fees paid by each user is managed as a payment status. For example, the work for collecting usage fees from each user is outsourced to an outside company; and the server group 5 stores in the user-payment management table UPT only the total usage fees collected in each month. This enables omission of the calculation processing in the above-described step Se2.

In the embodiment, all users pay a fixed usage fee each month; however, the present invention is not limited to such an embodiment.

For example, users may be divided into a plurality of classes, and the usage fee for each user may be changed depending on his or her class. Conceivably, various classification methods may be used. In one method, classification is performed depending on the usage status of the user, such as download count, execution time, and activation count. In another method, classification is performed depending on the difference in the amount of resources, such as a database, which the server group 5 reserves for the user.

In the embodiment, no restriction is imposed on any user in relation to use of any application. That is, each user can use a downloaded application without restriction. However, the present invention is not limited to such an embodiment, and some restriction may be introduced in relation to use of respective applications. For example, for each user, an upper limit may be imposed on at least one of download count, activation count, and execution time.

Next, another embodiment which employs the above-described restriction on use will be described.

First, it is assumed that use is restricted such that each user can download an application up to 20 times per month, can activate the application up to 100 times per month, and can execute the application up to 300 min per month.

The following sequence is used in order to check whether usage by any user exceeds these limits.

When the cellular-phone-dedicated WWW server 50 receives a download request signal from the cellular phone 10 of a user (the above-described step Sb25), the cellular-phone-dedicated WWW server 50 calculates the total download count of the user this month by reference to the user-access storing table UAT in the database server 54. When the calculated download count is not less than 20 (download-count upper limit), the cellular-phone-dedicated WWW server 50 transmits to the cellular phone 10 a message notifying the user that the application cannot be downloaded. This processing enables checking as to whether the download count has exceeded the upper limit.

When an application is started on the cellular phone 10 and the cellular-phone-dedicated WWW server 50 receives a start signal from the cellular phone 10 (the above-described step Sc4), the cellular phone-dedicated WWW server 50 calculates the total activation count and the execution time of the user this month, by reference to the user-access storing table UAT in the database server 54. When the calculated activation count is not less than 100 (activation-count upper limit) or when the calculated execution time is not less than 300 min (execution-time upper limit), the cellular-phone-dedicated WWW server 50 transmits to the cellular phone 10 a message notifying the user that the application cannot be started or executed. This processing enables checking as to whether the activation count has exceeded the upper limit. When the activation count exceeds the activation-count upper limit or when the execution time exceeds the execution-time upper limit, downloading of the application, rather than start or execution of the application, may be prohibited.

As has been described in relation to high-score registration processing, in the embodiment, an accessible table is defined on an application-by-application basis; however, a similar effect is obtained even when an accessible table is defined for each provider of applications.

In the embodiment, an ID is embedded in a URL or a hidden parameter of an input tag for identifying each session. However, this session management may be performed through issuing a special session identifier to thereby use a cookie file. Alternatively, authentication itself may be performed by use of basic authentication, which is a function of a WWW server.

In the embodiment, storage of an application is performed intentionally; however, the application may be cached into a temporary storage memory which is used for operating the application on the browser of the cellular phone 10.

In the embodiment, HTML data are used; however, other description languages such as XML (Extensible Markup Language) may be used.

In the present embodiment, the names of applications for which a user can vote are displayed in the form of a list. However, the manner of displaying the application names is not limited thereto. For example, a voting page for an application may be displayed in response to input of the corresponding application ID or application name or a user interface created by HTML data transmitted from the cellular-phone-dedicated WWW server 50. In this case, when the cellular-phone-dedicated WWW server 50 receives an HTTP request accompanied by an application ID or application name, the cellular-phone-dedicated WWW server 50 checks whether the application ID or application name is present. When the application ID or application name is not present, the cellular-phone-dedicated WWW server 50 causes the cellular phone 10 to display an error message.

Further, the voting operation may be modified such that when a user having logged in to the cellular-phone-dedicated WWW server 50 has not performed download, start, execution, or point voting for a designated application within the past three months, a message indicating that voting by the user is invalid is displayed.

In the embodiment, an input interface for point voting is formed by means of an HTML form. However, an alternative method may be employed. That is, an interface is provided on an application to be downloaded to the cellular phone 10 in order to allow transmission of voting data directly from the input interface on the application.

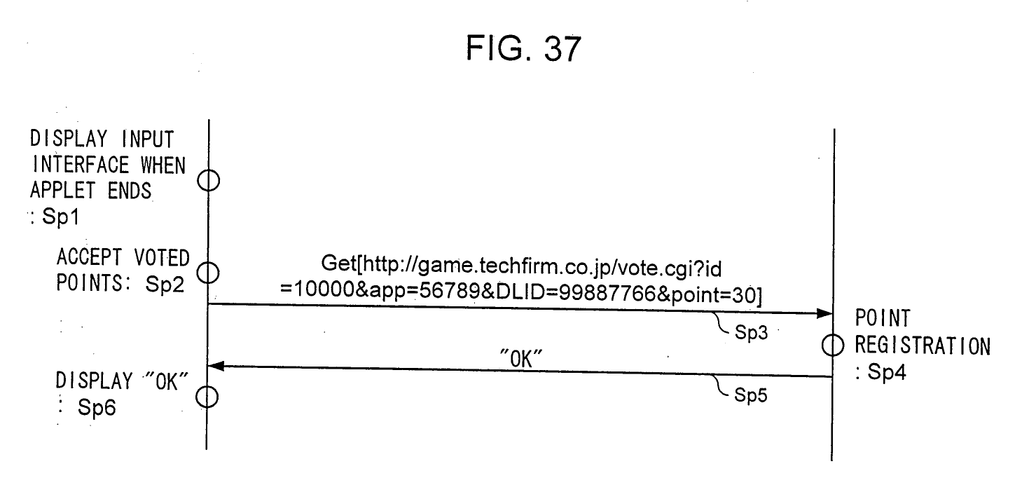

FIG. 37 is a sequence diagram showing the operations of the cellular phone 10 and the-cellular phone-dedicated WWW server 50 in such a case. As shown in FIG. 37, upon completion of performance of an applet; e.g., at game over, the cellular phone 10 displays an input interface for point input (step Sp1) and accepts an input from the user (step Sp2). Subsequently, the cellular phone 10 transmits to the cellular-phone-dedicated WWW server 50 a get request including “http://game.techfirm.co.jp/56789/vote.cgi?id=10000&app56799&DLID99887766&point30.” (scheme is “http:”, for example)

Meanwhile, a server application for receiving the voting data is prepared in the cellular-phone-dedicated WWW server 51. When a voting point is input directly to the input interface of the application on the cellular phone 10 and transmitted, the cellular-phone-dedicated WWW server 51 judges that the user uses that application. In this case, the cellular-phone-dedicated WWW server 50 accepts the voting even when data which relate to download, activation, and point voting and which are accumulated in the database server 54 were stored more than three months previously. This enables a server group to accept the voting point even when the server group cannot detect activation of an application on the cellular phone 10 side.

In the embodiment, a unique download ID is issued for each download request and is embedded in the param tag within the HTML data which designate download; the cellular phone 10 stores and uses the download ID to thereby secure safety of communications. However, the following method may be employed if the cellular phone 10 has a function of storing a URL for obtaining HTML data which designate download, and the application on the cellular phone 10 side can obtain the URL.

The cellular-phone-dedicated WWW server 50 adds a download ID to a URL for obtaining HTML data which designate download. When the application on the cellular phone 10 requests the HTML data which designate download by use of the URL, the cellular-phone-dedicated WWW server 50 stores in the download-ID management table DIT a user ID, an application ID, and a download ID contained in the request. When the application on the cellular phone 10 requires the download ID, the application obtains the URL from the application interface of the cellular phone, extracts from the URL the download ID only or data containing the same, and transmits to the cellular-phone-dedicated WWW server 50. Thus, the server 50 can confirm the combination of the user ID, the application ID, and the download ID, by reference to the download management table DIT.

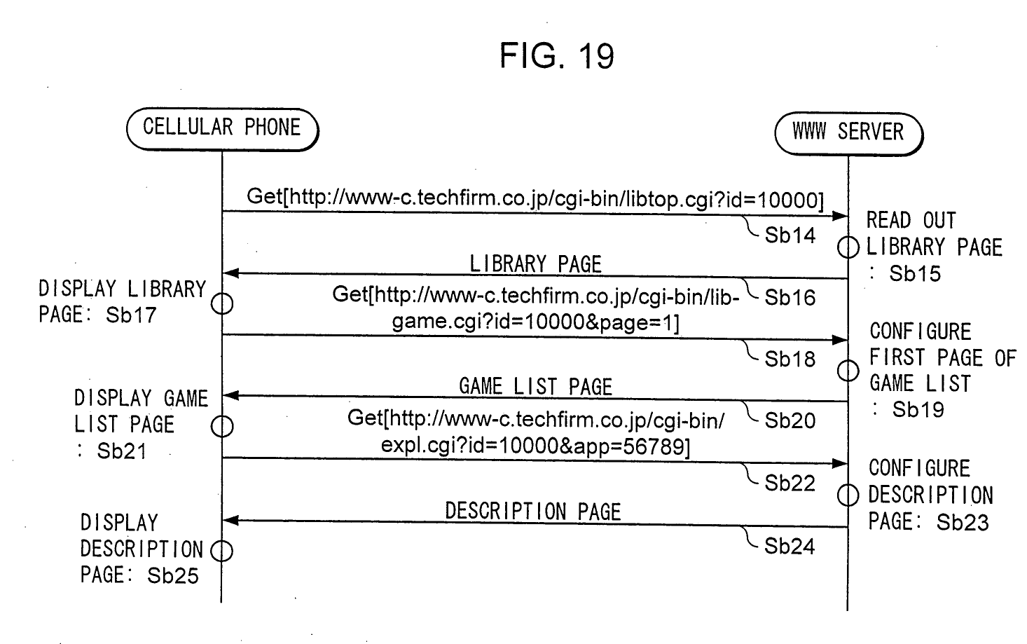

In the case of the present embodiment, when the cellular-phone-dedicated WWW server 50 configures a description page in step Sb22 in FIG. 19, the cellular-phone-dedicated www server 50 embeds “(scheme)://game.techfirm.co.jp/56789/dl.cgi?id=10000&app=56789&dlid=99887766” (scheme is “http:”, for example), as an hyperlink URL, in the menu item “download” shown in FIG. 21(f). When the user selects “download” (step Sb25 in FIG. 20), the above-described URL is transmitted to the cellular-phone-dedicated WWW server 50. At this time, the URL “(scheme)://game.techfirm.co.jp/56789/dl.cgi?id=10000&app=56789&dlid=99887766” (scheme is “http:”, for example) is stored in the cellular phone 10. Further, a similar effect is obtained when the URL which is in a form format and which is configured by the browser on the cellular phone 10 performs transmission in the above-described manner.

Further, the following method may be employed if the cellular phone 10 has a function of storing a URL of an application which designates download, and the application on the cellular phone 10 side can obtain the URL.

When the cellular-phone-dedicated WWW server 50 generates HTML data which designate download (step Sb26 in FIG. 20), the cellular-phone-dedicated WWW server 50 issues a unique download ID. In addition to the URL of an application, the cellular phone 10 transmits a request for download of the application by use of the URL. In response thereto, the cellular-phone-dedicated WWW server 50 stores in the download-ID management table DIT a user ID, an application ID, and a download ID. When the application on the cellular phone 10 requires the download ID, the application obtains the URL from the application interface of the cellular phone 10, extracts from the URL the download ID only or data containing the same, and transmits it to the cellular-phone-dedicated www server 50. Thus, the server 50 can confirm the combination of the user ID, the application ID, and the download ID.

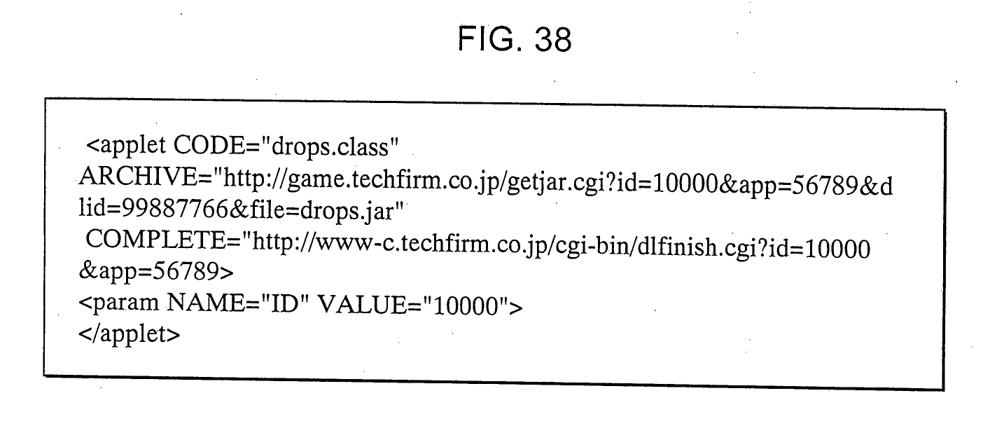

In the case of the embodiment, in step Sb26 shown in FIG. 20, an application designating tag as shown in FIG. 38 is generated, and HTML data containing this tag are returned to the cellular phone.

A server application getjar.cgi is disposed on the server side as shown in the drawing. When the application is started, user ID “10000,” application ID “56789,” and download ID “99887766” are stored in the download-ID management table DIT together with the date and time at which the request has been received. Subsequently, the application drops.jar is returned to the cellular phone 10.

At this time, the URL “(scheme)://game.techfirm.co.jp/getjar.cgi?id=10000&app=56789&dlid=99887766&file=drops.jar” (scheme is “http:”, for example) is stored in the cellular phone 10.

When the cellular phone has a memory area in which the application can store data and the application can be referred to, the download ID is not provided from the cellular-phone-dedicated WWW server 50 beforehand, but the download ID can be obtained from the server 50 and stored, at an arbitrary time before the application transmits the download ID to the server 50.

That is, in the embodiment, when the cellular phone 10 first starts an application and transmits its request to the server 50 as in step Sc4 of FIG. 23, “(scheme)://game.techfirm.co.jp/start.cgi?id=10000&app=56789&DLID=” (scheme is “http:”, for example) is used as a URL. Thus, the URL with empty “DLID” can be transmitted. In step Sc5, the server 50 issues a unique download ID and stores it in the download-ID table DIT. In step Sc6, the server 50 transmits a character message “OK/dlid=99887766” to the application.

Upon receipt of the character message, the application stores the received download ID “99887766” in a memory area of the cellular phone 10 provided for download ID storage.

When the cellular phone 10 can store date and time at which an application is downloaded and permits the application to refer to the download date and time, on the server 50 side, the date and time are stored in the last-download management table LDT as date and time at which the user indicated by the user ID last downloaded the application indicated by the application ID. When the application must transmit to the cellular-phone-dedicated WWW server 50 data for identifying itself, the application obtains data indicating its own download date and time from the application interface of the cellular phone 10 and transmits the data to the cellular-phone-dedicated WWW server 50 together with the user ID and the application ID. On the server 50 side, the last-download management table LDT is scanned, to thereby obtain the download date and time corresponding to the combination of user ID and application ID; and the difference between the thus-obtained download date and time and those on the portable phone 10 is calculated. When the difference falls within an allowable range determined in consideration of download overhead time (e.g. within ±10 min), the application is judged to be correctly identified.

For example, in the embodiment, “(scheme)://game.techfirm.co.jp/vote.cgi?id=1000&app=56789&dltime=200006031925&point=20” (scheme is “http:”, for example) is used as a URL in step Sd10 shown in FIG. 27. “dltime=200006031925” means that the application was downloaded at 19:25 on June 3, 2000. Upon receipt of this request, the cellular-phone-dedicated WWW server 50 searches a download date and time on the last-download management table DIT while using user ID “10000” and application ID “56789” as keys, to thereby judge the validity of the download date and time.

1. (canceled)

2. An application distribution system that distributes applications to user terminals connectable to the application distribution system via at least one public network, comprising:
provider table configured to store identifications of applications available for download by users of the user terminals and identifications of application providers who provide the applications;
usage table configured to record usages of the applications by the users;
fee table configured to record fees collected from the users who each pay a fixed amount of fee periodically; and
calculator configured to calculate allocations of the fees collected from the users among the application providers according to at least one of the usages of the applications by the users recorded in the usage table.

3. An application distribution system according to claim 2, wherein the calculator first determines usages of an application and then determines an allocation of the fees for the application.

4. An application distribution system according to claim 2, wherein the calculator first determines usages of applications by a user and then determines allocations of the fee among the applications.

5. An application distribution system according to claim 2, wherein one of the usages of an application is a number of downloads of the application.

6. An application distribution system according to claim 2, wherein one of the usages of an application is time lengths during which the application is executed.

7. An application distribution system according to claim 6, wherein the application distribution system receives notices from a user terminal when the terminal starts to execute an application and ends the execution of the application.

8. An application distribution system according to claim 2, wherein one of the usages of an application is a number of times the application is activated on user terminals.

9. An application distribution system according to claim 2, wherein one of the usages of an application is a rating made by users for the application, and the system further comprise a rating control configured to count the ratings made by the users.

10. An application distribution system according to claim 9, wherein the rating control sets a limitation to a number of ratings one user can make during a time period.

11. An application distribution system according to claim 10, wherein the rating control is responsive to a request from a user to create a list of applications for which the user can rate.

12. An application distribution system according to claim 11, wherein in response to the request from the user, the rating control makes a list of applications which were downloaded by the user for a period of time.

13. An application distribution system according to claim 11, wherein in response to the request from the user, the rating control makes a list of applications which were activated by the user for a period of time.

14. An application distribution system according to claim 11, wherein in response to the request from the user, the rating control makes a list of applications which were rated by the user for a period of time.

15. An application distribution system according to claim 9, wherein the rating control counts a rating by a user only if the rating is made for any one of (i) an application which was downloaded by the user for a period of time, (ii) an application which was activated by the user for the period of time and (iii) an application which was rated by the user for the period of time.

16. An application distribution system according to claim 9, wherein the rating control generates a list of applications from which a user may select an application for rating and when the user selects an application from the list for rating, judges whether the user is eligible to select the application for rating.

17. An application distribution system according to claim 2, wherein the calculator calculates allocations of the fees among the application providers, based on at least two usages selected from a group consisting of (i) a number of downloads of the applications by the uses, (ii) a number of times the applications were activated by the users and (iii) time lengths the applications were executed by the users.

18. An application distribution system according to claim 2, further comprising an application locator responsive to a request from a user to locate an application and send the user information comprising at least a title and a description of the requested application.

19. An application distribution system according to 18, further comprising a message transmitter configured to send the user information on a location of the requested application.

20. An application distribution system according to claim 19, further comprising a graphic interface generator configured to present a graphic interface which allows the user to request the application.

21. An application distribution system according to claim 2, further comprising payment control which allows payment of an allocation of the fees to a corresponding application provider only if the allocation exceeds a certain amount.

22. An application distribution system according to claim 21, wherein the payment control sums allocations for an application provider over a time.

23. An application distribution system according to claim 2, wherein the fee table records a fee collected from each user.

24. An application distribution system according to claim 2, wherein the fee tale records total fees collected from each user.

25. An application distribution system according to claim 2, wherein the fee is equal for all the users.

26. An application distribution system according to claim 2, wherein the fee is equal for uses in a group.

27. An application distribution system according to claim 2, further comprising a download control which prohibits a user from downloading an application if a number of times the user has downloaded the application over a certain period of time exceeds a certain number.

28. An application distribution system according to claim 2, further comprising an execution time control which prohibits a user from at least one of (i) downloading an application and (iii) activating the application on the user's user terminal if total time lengths the user executed the application exceed a certain time length.

29. An application distribution system according to claim 2, further comprising an activation control which prohibits a user from at least one of (i) downloading an application and (ii) activating the application on the user's user terminal if total numbers the user activating the application exceed a certain number.

30. An application distribution system according to claim 9, wherein the application comprises an interface program which allows a user to rate the application.

31. An application distribution system according to claim 30, wherein the rating control accepts a rating from a user only when the rating is for any one of (i) an application which was downloaded by the user for a period of time, (ii) an application which was activated by the user for the period of time and (iii) an application which was rated by the user for the period of time.

32. An application distribution system according to claim 2, further comprising:
a server program memory area that stores a plurality of server programs which communicate with applications downloaded on the user terminals;
a common database area to which the server programs have access; and
a restriction control which defines for each of the server programs table areas which a respective server program cannot access.

33. An application distribution system according to claim 2, further comprising:
a server program memory area that stores a plurality of server programs which communicate with applications downloaded on the user terminals;
a common database area to which the server programs have access; and
a permission control which define for each of the server programs table areas which a respective server program can access.

34. An application distribution system according to claim 2, further comprising:
a user table which stores user information;
a server program memory area that stores a plurality of server programs which communicate with applications downloaded on the user terminals; and
a shared process interface which can access the user information stored in the user table, wherein the server programs access the user information in the user table via the shared process interface.

35. An application distribution method of distributing applications to user terminals connectable to the application distribution system via at least one public network, the method comprising:
storing identifications of applications available for download by users of the user terminals and identifications of application providers who provide the applications;
recording usages of the applications by the users;
recording fees collected from the users who each pay a fixed amount of fee periodically; and
calculating allocations of the fees collected from the users among the application providers according to at least one of the usages of the applications by the users recorded in the usage table.

36. An application distribution method according to claim 35, wherein calculating allocations of the fees comprising first determining usages of an application and then determining an allocation of the fees for the application.

37. An application distribution method according to claim 35, wherein calculating allocations of the fees comprising first determining usages of applications by a user and then determining allocations of the fee among the applications.
